(19) United States
(12) Patent Application Publication
(10) Pub. No.: US 2005/0266263 A1
(43) Pub. Date: Dec. 1, 2005

(54) Refractory solid, adhesive composition, and device, and associated method

(75) Inventors: John Robert Campbell, Clifton Park, NY (US); Sandeep Shrikant Tonapi, Niskayuna, NY (US); Ananth Prabhakumar, Clifton Park, NY (US); David Alexander Gibson III, Scotia, NY (US); Slawomir Rubinsztajn, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/155,990

(22) Filed: Jun. 17, 2005

Related U.S. Application Data
(63) Continuation-in-part of application No. 11/096,160, filed on Apr. 1, 2005.
Application No. 11/096,160 is a continuation-in-part of application No. 10/737,943, filed on Dec. 16, 2003.
Application No. 10/737,943 is a continuation-in-part of application No. 10/654,378, filed on Sep. 3, 2003.
Application No. 10/737,943 is a continuation-in-part of application No. 10/736,946, filed on Dec. 16, 2003.
Application No. 11/096,160 is a continuation-in-part of application No. 11/006,265, filed on Dec. 7, 2004.
Application No. 11/006,265 is a continuation-in-part of application No. 10/653,371, filed on Sep. 2, 2003.
Application No. 11/006,265 is a continuation-in-part of application No. 10/301,904, filed on Nov. 22, 2002, now abandoned.

(51) Int. Cl. B32B 15/00

(52) U.S. Cl. 428/624; 428/655; 428/661; 257/788; 428/626

(57) ABSTRACT

A finely divided refractory solid and an associated method are provided. The solid may have a surface area that is greater than about 5 square meters per gram. The solid may have a density of active surface termination sites per square nanometer of surface area sufficiently low that a curable composition comprising a curable resin that comprises less than about 99 percent by weight of the solid has a stability ratio of less than about 3 after a period of about two weeks. Also, a curable composition, a cured layer, and an electronic device that includes the cured layer are provided.

### CROSS REFERENCE TO RELATED APPLICATIONS

This patent application is a continuation-in-part patent application of U.S. patent application Ser. No. 11/096,160 filed Apr. 1, 2005, which is a continuation-in-part patent application of U.S. patent application Ser. No. 10/737,943 filed Dec. 16, 2003, which is a continuation-in-part patent application of U.S. patent application Ser. No. 10/654,378 filed Sep. 3, 2003; U.S. patent application Ser. No. 10/736,946 filed Dec. 16, 2003; U.S. patent application Ser. No. 11/006,265 filed Dec. 7, 2004, which is a continuation-in-part patent application of U.S. patent application Ser. No. 10/301,904 filed on Nov. 22, 2002; and, U.S. patent application Ser. No. 10/653,371 filed on Sep. 2, 2003. The benefit and priority of these patent applications are hereby claimed. The entire contents of each of these patent applications are hereby incorporated by reference in their entirety.

### BACKGROUND

1. Technical Field

The invention may include embodiments that relate to a filler for use in an adhesive composition. The invention may include embodiments that relate to the adhesive composition, and to a device using the adhesive composition. The invention may include embodiments that relate to a method of making and/or using the filler.

2. Discussion of Related Art

Demand for smaller and more sophisticated electronic devices continues to drive the electronic industry towards integrated circuit packages capable of supporting higher input/output (“I/O”) density, and having enhanced performance at smaller die areas. Flip chip technology has been developed to respond to industry demand. But, a flip chip construct may experience undesirable mechanical stress at solder bumps during thermal cycling. The mechanical stress may be due to coefficient of thermal expansion (“CTE”) mismatch between a silicon die and a substrate. This mismatch may result in mechanical and electrical failures of the electronic device. Currently, an underfill resin may be used to fill gaps between silicon chip and substrate to reduce the mechanical stress. Further, the underfill resin may include a silicon filler to reduce CTE mismatch.

The use of silicon filler may be problematic in that the filled underfill resin may obscure guide marks used for wafer dicing, may interfere with the formation of electrical connections during solder reflow operations, and may be difficult to process. It may be desirable to have on or more of a filler material, a filled resin system, and an electronic device with different properties than currently available.

### BRIEF DESCRIPTION

The invention includes embodiments that may relate to a finely divided refractory solid. The solid may have a surface area that is greater than about 5 square meters per gram. The solid may have a density of active surface termination sites per square nanometer of surface area sufficiently low that a curable composition comprising a curable resin that comprises less than about 99 percent by weight of the solid has a stability ratio of less than about 3 after a period of about two weeks.

Embodiments of the invention may relate an adhesive composition. The adhesive composition may include a solid and a curable resin. The solid may have a surface area that is greater than about 5 square meters per gram. The solid may have a density of active surface termination sites per square nanometer of surface area sufficiently low that a curable composition comprising a curable resin that comprises less than about 99 percent by weight of the solid has a stability ratio of less than about 3 after a period of about two weeks.

Embodiments of the invention may relate to an electronic device. The device may include a chip, a substrate, and an adhesive composition securing the chip to the substrate. The adhesive composition may include a solid and a curable resin. The solid may have a surface area that is greater than about 5 square meters per gram. The solid may have a density of active surface termination sites per square nanometer of surface area sufficiently low that a curable composition comprising a curable resin that comprises less than about 99 percent by weight of the solid has a stability ratio of less than about 3 after a period of about two weeks.

An embodiment may relate to a method of producing a stable, filled resin system. The method may include reacting a first portion of active termination sites of a plurality of particles with a functionalizing composition; and reacting a second portion of active termination sites of the plurality of particles with a passivating composition.

### BRIEF DESCRIPTION OF THE DRAWINGS

FIG. 1 is a graph that illustrates a relationship between active termination site density and viscosity; and

FIG. 2 is a graph that illustrates active termination site density versus stability.

### DETAILED DESCRIPTION

The invention may include embodiments that relate to a filler for use in an adhesive composition. The invention may include embodiments that relate to the adhesive composition, and to a device using the adhesive composition. The invention may include embodiments that relate to a method of making and/or using the filler.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, may be not to be limited to the precise value specified. Cured refers to a total formulation with reactive groups wherein more than about 50 percent of the reactive groups have reacted. B-stage resin is a subsequent cure stage of a thermosetting resin in which a partially cured resin may be rubbery and may have only partially solubility in solvent. Glass transition temperature may be the temperature as which an amorphous material changes from a hard or brittle state to a soft or plastic state. Transparent refers to a maximum haze percentage of 15. A substrate has a surface to which a chip or component may be secured. A low boiling point component may be a component of a mixture or solution that has a boiling point of less than or equal to about 200 degrees Celsius at about 1 atmosphere. Resins may be disclosed throughout the specification and claims, and refer both to the specifically-named resin and to molecules having a moiety of the named resin. Further, resin may include monomeric units of the resin, oligomers and partially cured molecules of the resin, and fully cured resin materials formed from the monomeric units. Alkyl may include one or more of alkyl, branched alkyl, aralkyl, and cycloalkyl radicals.

In one embodiment, a filler of silica may be treated with at least one organoalkoxysilane and at least one organosilizane. The treatment may be done sequentially or simultaneously. In sequential treatment, the organoalkoxysilane may be applied or reacted with at least a portion of active termination sites on the surface of the filler, and the organosilizane may be applied or reacted with at least a portion of the active termination sites that remain after the reaction with the organoalkoxysilane.

After the reaction with the organoalkoxysilane, the otherwise phase incompatible filler may be relative more compatible with an organic phase, such as an organic resin. Even though phase compatible with the pendant organic groups from the reaction with the organoalkoxysilane, residual active termination sites on the surface of the filler may initiate premature crosslinking of the organic resin.

The phase compatible filler may be passivated by the capping of the active termination sites by the organosilizane. The phase compatible, passivated filler may be admixed with a resin, and may form a stable filled resin system. The organoalkoxysilane and the organosilizane are examples of a phase compatiblizer and a passivator, respectively.

A solvent-modified resin composition may include a curable resin matrix of at least one aromatic epoxy resin and at least one cycloaliphatic epoxy resin, aliphatic epoxy resin or hydroxy aromatic compounds, or mixtures thereof, or combinations thereof. The resin matrix may be combined with at least one solvent, and a dispersion of particle filler. An aromatic epoxy resin may be an epoxy derived from novolac cresol resin. In another embodiment, the particle filler dispersion comprises at least one functionalized colloidal silica in an aqueous media. The solvent-modified resin composition may include one or more hardeners and/or catalysts, among other additives. Upon heating and removal of solvent, the combination forms a transparent B-stage resin. In one embodiment, a solvent-modified resin compositions that may be useful as underfill materials, which may be applicable in the flip chip technology. After removal of the solvent, the underfill materials may be finally curable by heating to a transparent B-stage, cured, hard resin with a low CTE, and high glass transition temperature. The colloidal silica filler may be uniformly distributed throughout the disclosed compositions that contain a solvent, and this distribution may remain stable at room temperature and during removal of solvent and any curing steps. The resin transparency of the resulting resin may be useful as an underfill material, especially a wafer level underfill, for wafer dicing operations to render wafer dicing guide marks visible during wafer dicing operations. The disclosed compositions may be a useful underfill as, for example, a wafer level underfill. In certain embodiments, the underfill material may have self-fluxing capabilities.

Suitable resins for use in a curable resin matrix may include one or more of epoxy resins, polydimethylsiloxane resins, acrylate resins, other organo-functionalized polysiloxane resins, polyimide resins, fluorocarbon resins, benzocyclobutene resins, fluorinated polyallyl ethers, polyamide resins, polyimidoamide resins, phenol cresol resins aromatic polyester resins, polyphenylene ether (PPE) resins, bismaleimide triazine resins, fluororesins and a polymeric system which may undergo curing to a highly crosslinked thermoset material. (See “Polymer Handbook”, Branduf, J.; Immergut, E. H.; Grulke, Eric A.; Wiley Interscience Publication, New York, 4th ed. (1999); “Polymer Data Handbook”; Mark, James, Oxford University Press, New York (1999)). A curable thermoset material may be epoxy resins, acrylate resins, polydimethyl siloxane resins and other organo-functionalized polysiloxane resins that may form cross-linking networks via free radical polymerization, atom transfer, radical polymerization, ring-opening polymerization, ring-opening metathesis polymerization, or anionic polymerization, cationic polymerization. Suitable curable silicone resins may include, for example, the addition curable and condensation curable matrices as described in “Chemistry and Technology of Silicone”; Noll, W., Academic Press (1968).

The epoxy resin utilized in the first resin composition may be an epoxy resin matrix including at least one aromatic epoxy resin and at least one cycloaliphatic epoxy monomer, aliphatic epoxy monomer, or hydroxy aromatic compound, or a mixture of any one of the above. The epoxy resins may include any organic system or inorganic system with epoxy functionality. Useful epoxy resins may include those described in “Chemistry and Technology of the Epoxy Resins,” B. Ellis (Ed.) Chapman Hall 1993, New York and “Epoxy Resins Chemistry and Technology,” C. May and Y. Tanaka, Marcel Dekker, New York (1972), which is hereby incorporated by reference to the extent that it discloses epoxy resin. Epoxy resins may be curable monomers and oligomers, which may be blended with the filler dispersion. The epoxy resins may include an aromatic epoxy resin or an alicyclic epoxy resin having two or more epoxy groups in its molecule. The epoxy resins may have two or more functional groups. Useful epoxy resins also may include those that could be produced by reaction of a hydroxyl, carboxyl or amine-containing compound with epichlorohydrin in the presence of a basic catalyst. Epoxy resins may be produced by reaction of a compound containing at least one and two or more carbon-carbon double bonds with peroxide, such as a peroxyacid.

Addition of polyfunctional aromatic resins may increase a glass transition temperature (T_{g}). Suitable aromatic epoxy resins may include one or more cresol-novolac epoxy resins, bisphenol-A epoxy resins, bisphenol-F epoxy resins, phenol novolac epoxy resins, bisphenol epoxy resins, biphenyl epoxy resins, 4,4′-biphenyl epoxy resins, polyfunctional epoxy resins, divinylbenzene dioxide, and 2-glycidylphenylglycidyl ether. Examples of trifunctional aromatic epoxy resins may include triglycidyl isocyanurate epoxy, VG3101L manufactured by Mitsui Chemical and the like, and examples of tetrafunctional aromatic epoxy resins may include by Araldite MTO163 manufactured by Ciba Geigy and the like. In one embodiment, epoxy resins for use with the disclosure may include cresol-novolac epoxy resins, and epoxy resins derived from bisphenols.

Multi-functional epoxy monomers may be may included in the first resin composition of the disclosure in amounts ranging from about 1 weight percent to about 5 weight percent, from about 5 weight percent to about 35 weight percent, from about 35 weight percent to about 70 weight percent, or greater than about 70 weight percent of the total composition. Here and throughout the specification and claims, range limitations may be combined and/or interchanged, such ranges are identified and include all the sub-ranges contained therein unless context or language indicates otherwise. An amount of epoxy resin may be adjusted to correspond to molar amount of other reagents such as novolac resin hardeners.

Suitable cycloaliphatic epoxy resins may include one or more of 3-(1,2-epoxy ethyl)-7-oxabicyclo heptane; hexanedioic acid bis (7-oxabicyclo heptylmethyl) ester; 2-(7-oxabicyclohept-3-yl)-spiro (1,3-dioxa-5,3′-(7)-oxabicycloheptane; methyl 3,4-epoxycyclohexane carboxylate, 3-cyclohexenyl methyl-3-cyclohexenyl carboxylate diepoxide, 2-(3,4-epoxy) cyclohexyl-5,5-spiro-(3,4-epoxy) cyclohexane-m-dioxane, 3,4-epoxy cyclohexylalkyl-3,4-epoxycyclohexanecarboxylate, 3,4-epoxy-6-methyl cyclohexylmethyl-3,4-epoxy-6-methyl cyclohexane carboxylate, vinyl cyclohexanedioxide, bis (3,4-epoxy cyclohexylmethyl) adipate, bis (3,4-epoxy-6-methylcyclohexylmethyl) adipate, exo-exo bis (2,3-epoxy cyclopentyl) ether, endo-exo bis (2,3-epoxy cyclopentyl) ether, 2,2-bis (4-(2,3-epoxy propoxy) cyclohexyl) propane, 2,6-bis (2,3-epoxy propoxy cyclohexyl-p-dioxane), 2,6-bis (2,3-epoxy propoxy) norbornene, diglycidyl ether of linoleic acid dimer, limonene dioxide, 2,2-bis (3,4-epoxy cyclohexyl) propane, dicyclo pentadiene dioxide, 1,2-epoxy-6-(2,3-epoxy propoxy) hexahydro-4,7-methanoindane, p-(2,3-epoxy) cyclopentyl phenyl-2,3-epoxy propylether, 1-(2,3-epoxy propoxy) phenyl-5,6-epoxy hexahydro-4,7-methanoindane, o-(2,3-epoxy) cyclopentyl phenyl-2,3-epoxy propyl ether), 1,2-bis (5-(1,2-epoxy)-4,7-hexahydro methanoindanoxyl) ethane, cyclo pentenyl phenyl glycidyl ether, cyclohexanediol diglycidyl ether, butadiene dioxide, dimethylpentane dioxide, diglycidyl ether, 1,4-butanedioldiglycidyl ether, diethylene glycol diglycidyl ether, and dipentene dioxide, and diglycidyl hexahydrophthalate. A suitable cycloaliphatic epoxy resin may be 3-cyclohexenylmethyl-3-cyclohexenylcarboxylate diepoxide.

Cycloaliphatic epoxy monomers may be included in a solvent-modified resin composition in an amount in a range of from about 0.3 weight percent to about 0.5 weight percent, from about 0.5 weight percent to about 10 weight percent, from about 10 weight percent to about 15 weight percent, or greater than about 15 weight percent of the first resin composition.

Suitable aliphatic epoxy resins may include compositions having an aliphatic group, such as C₄-C₂₀ aliphatic resins or polyglycol type resins. The aliphatic epoxy resin may be either monofunctional, i.e. one epoxy group per molecule, or polyfunctional, i.e. two or more epoxy groups per molecule. In one embodiment, the aliphatic epoxy resin may include one or more of butadiene dioxide, dimethylpentane dioxide, diglycidyl ether, 1,4-butanedioldiglycidyl ether, diethylene glycol diglycidyl ether, and dipentene dioxide. Such aliphatic epoxy resins may be available commercially, such as DER 732 and DER 736 from Dow Chemical (Midland, Mich.).

The aliphatic epoxy monomers may be included in a solvent-modified resin composition in an amount in a range of from about 0.3 weight percent to about 0.5 weight percent, from about 0.5 weight percent to about 10 weight percent, from about 10 weight percent to about 15 weight percent, or greater than about 15 weight percent of the first resin composition.

Suitable silicone-epoxy resins may have a formula (I):
MₐM′_{b}D_{c}D′_{d}TₑT′_{f}Q_{g} (I)
where the subscripts a, b, c, d, e, f and g may be zero or a positive integer, subject to the limitation that the sum of the subscripts b, d and f may be one or greater; where M has the formula: R¹₃SiO_{1/2}; M′ has the formula: (Z)R²₂SiO_{1/2}; D has the formula: R³₂SiO_{2/2}; D′ has the formula: (Z)R⁴SiO_{2/2}; T has the formula: R⁵SiO_{3/2}; T′ has the formula: (Z)SiO_{3/2}; and Q has the formula SiO_{4/2}. Each of R¹, R², R³, R⁴, R⁵ may be independently at each occurrence a hydrogen atom, about C1-C22 alkyl, about C1-C22 alkoxy, about C2-C22 alkenyl, about C6-C14 aryl, about C6-C22 alkyl-substituted aryl, or about C6-C22 arylalkyl, and may be halogenated, for example, fluorinated to contain fluorocarbons such as about C1-C22 fluoroalkyl, or may contain amino groups to form aminoalkyls, for example aminopropyl or aminoethylaminopropyl, or may contain polyether units of the formula (CH₂CHR⁶O)ₖ where R⁶ may be methyl or hydrogen and k may be in a range of from about 4 to about 20; and Z, independently at each occurrence, may represent a radical containing an epoxy group. Normal and branched alkyl radicals may contain in a range of from about 1 or about 12 carbon atoms, and may include as illustrative non-limiting examples methyl, ethyl, propyl, isopropyl, butyl, tertiary-butyl, pentyl, neopentyl, and hexyl. Cycloalkyl radicals represented may be those containing in a range of from about 4 to about 12 ring carbon atoms. Some illustrative non-limiting examples of these cycloalkyl radicals may include cyclobutyl, cyclopentyl, cyclohexyl, methylcyclohexyl, and cycloheptyl. Aralkyl radicals may be those containing in a range of from about 7 to about 14 carbon atoms; these may include, but may be not limited to, benzyl, phenylbutyl, phenylpropyl, and phenylethyl. Aryl radicals used in the various embodiments of the disclosure may include those containing in a range of from about 6 to about 14 ring carbon atoms. Some illustrative non-limiting examples of these aryl radicals may include phenyl, biphenyl, and naphthyl. An illustrative non-limiting example of a halogenated moiety suitable may be 3,3,3-trifluoropropyl. Combinations of epoxy monomers and oligomers may be also contemplated for use with the disclosure.

In one embodiment, a combination of resin materials may be useful as an underfill material. The underfill material may include two or more resins: a first curable transparent resin composition, and a second curable fluxing resin composition. The first curable resin composition may be applied at the wafer stage, and forms a hard, transparent B-stage resin upon solvent removal. The wafer may be then subjected to dicing or similar operations to produce individual chips. However, in some embodiments the first curable resin may be applied to an individual chip after dicing. The second curable fluxing resin may be applied to the substrate or device to which the chip may be to be applied. The second curable fluxing resin holds the chip in place during reflow operations, thereby limiting misalignment of the chip.

In one embodiment, a first curable resin composition may include a resin matrix having at least one epoxy resin. The first curable resin composition may be selected from the group of suitable resin compositions disclosed above. Particularly, the first curable resin composition may include at least one aromatic epoxy resin and at least one cycloaliphatic epoxy resin, aliphatic epoxy resin, hydroxy aromatic compound, or mixtures thereof, or combinations thereof. The resin matrix may be combined with at least one solvent and a particle filler dispersion. In one embodiment, the aromatic epoxy resin may be an epoxy derived from novolac cresol resin. In another embodiment, the particle filler dispersion comprises at least one functionalized colloidal silica. The first curable resin composition may include one or more hardeners and/or catalysts, among other additives. Upon heating and removal of solvent, the first curable resin forms a transparent B-stage resin, sometimes referred to herein as a “solvent-modified resin.” The transparency of the first solvent-modified resin material may be especially useful as a wafer level underfill, to render wafer dicing guide marks visible during wafer dicing operations.

The second curable fluxing resin composition of the disclosure may include a resin matrix of at least one epoxy resin. The fluxing resin may be a low viscosity liquid, and may include an epoxy hardener. In one embodiment, the second curable fluxing resin may include at least one functionalized colloidal silica.

The combination of the two resins produces underfill materials, which may be finally curable by heating to a cured, hard resin with a low CTE and high glass transition temperature. In certain embodiments, the underfill material may have self-fluxing capabilities. The colloidal silica filler may be uniformly distributed throughout the disclosed compositions, and this distribution remains stable at room temperature and during removal of solvent from the first curable resin and any curing steps.

Suitable solvents for use with a resin (a single resin or a combination of resins) may include, for example, 1-methoxy-2-propanol, methoxy propanol acetate, butyl acetate, methoxyethyl ether, methanol, ethanol, isopropanol, ethyleneglycol, ethylcellosolve, methylethyl ketone, cyclohexanone, benzene, toluene, xylene, and cellosolves such as ethyl acetate, cellosolve acetate, butyl cellosolve acetate, carbitol acetate, and butyl carbitol acetate. These solvents may be used either singly or in the form of a combination of two or more members. In one embodiment, a solvent for use with this disclosure may be 1-methoxy-2-propanol. The solvent may be in the solvent-modified resin composition in an amount of from about 5 weight percent to about 70 weight percent, or about 15 weight percent to about 40 weight percent. Due to the addition of solvent, the first curable transparent resin may be sometimes referred to herein as a “solvent-modified resin,” and these terms may be used interchangeably.

Suitable filler starting material to make the modified fillers in the first resin composition of the disclosure may include a colloidal silica. The silica may be a dispersion of submicron-sized silica (SiO₂) particles in an aqueous or other solvent medium. The dispersion may include a silica content of less than about 10 weight percent, an amount in a range of from about 10 weight percent to about 30 weight percent, from about 30 weight percent to about 60 weight percent, from about 60 weight percent to about 85 weight percent, or greater than about 85 weight percent of silicon dioxide (SiO₂).

The average particle size of the colloidal silica may be in a range of from about 1 nanometer (nm) to about 5 nanometers, from about 5 nanometers to about 50 nanometers, or from about 50 nanometers to about 75 nanometers. The average particle size may be in a range of from about 75 nanometers to about 100 about nanometers, from about 100 nanometers to about 250 nanometers, or greater than about 250 nanometers. In one embodiment, the above disclosed range limitations may refer to a maximum particle size rather than an average particle size.

The colloidal silica may be functionalized or treated with an organoalkoxysilane to form a functionalized colloidal silica that may be compatible or dispersible in an organic or non-polar liquid phase. Organoalkoxysilanes used to functionalize the colloidal silica may be may included within the formula:
(R⁷)ₐSi(OR⁸)₄₋ₐ
where R⁷ may be independently at each occurrence an about C1-C18 monovalent hydrocarbon radical, optionally further functionalized with alkyl acrylate, alkyl methacrylate or an epoxide group, or an about C6-C14 aryl or alkyl radical, R⁸ may be at each occurrence independently an about C1-C18 monovalent hydrocarbon radical or a hydrogen radical and “a” may be a whole number equal to 1 to 3 inclusive. The organoalkoxysilanes may include one or more of phenyl trimethoxy silane, 2-(3,4-epoxy cyclohexyl) ethyl trimethoxy silane, 3-glycidoxy propyl trimethoxy silane, and methacryloxy propyl trimethoxy silane, and the like. In one embodiment, phenyl trimethoxysilane may be used to functionalize the colloidal silica. In one embodiment, phenyl trimethoxysilane may be used to functionalize the colloidal silica. A combination of functional group types may be suitable.

An organoalkoxysilane may be present in an amount less than about 0.5 weight percent, in a range of from about 0.5 weight percent to about 5 weight percent, or about 5 weight percent to about 60 weight percent based on the weight of silicon dioxide contained in the colloidal silica in the first resin composition.

The functionalization of colloidal silica may be performed by adding the functionalization agent to an aqueous dispersion of colloidal silica to which an aliphatic alcohol has been added. The resulting composition comprising the functionalized colloidal silica and the functionalization agent in the aliphatic alcohol may be defined herein as a pre-dispersion. The aliphatic alcohol may be selected from isopropanol, t-butanol, 2-butanol, and combinations thereof. The amount of aliphatic alcohol may be in a range of from about 1 fold to about 10 fold of the amount of silicon dioxide present in the aqueous colloidal silica pre-dispersion.

The resulting organofunctionalized colloidal silica may be treated with an acid or base to neutralize the pH. An acid or base as well as other catalyst promoting condensation of silanol and alkoxysilane groups may also be used to aid the functionalization process. Such catalysts may include organo-titanate and organo-tin compounds such as tetrabutyl titanate, titanium isopropoxybis(acetylacetonate), dibutyltin dilaurate, or combinations thereof. In some cases, stabilizers such as 4-hydroxy-2,2,6,6-tetramethylpiperidinyloxy (i.e. 4-hydroxy TEMPO) may be added to this pre-dispersion. The resulting pre-dispersion may be heated in a range of from about 50 degrees Celsius to about 100 degrees Celsius for a period in a range of from about 1 hour to about 12 hours. A curing time range of from about 1 hour to about 5 hours may be adequate.

The cooled transparent pre-dispersion may be then further treated to form a final dispersion. Optionally curable monomers or oligomers may be added and optionally, more aliphatic solvent which may be selected from isopropanol, 1-methoxy-2-propanol, 1-methoxy-2-propyl acetate, toluene, and combinations thereof. This final dispersion of the functionalized colloidal silica may be treated with acid or base or with ion exchange resins to remove acidic or basic impurities.

The final dispersion composition may be hand-mixed or mixed by standard mixing equipment such as dough mixers, chain may mixers, and planetary mixers. The blending of the dispersion components may be performed in batch, continuous, or semi-continuous mode by any means used by those skilled in the art.

This final dispersion of the functionalized colloidal silica may be then concentrated under a vacuum in a range of from about 0.5 Torr to about 250 Torr and at a temperature in a range of from about 20 degrees Celsius. to about 140 degrees Celsius. to substantially remove any low boiling components such as solvent, residual water, and combinations thereof to give a transparent dispersion of functionalized colloidal silica which may optionally contain curable monomer, here referred to as a final concentrated dispersion. Substantial removal of low boiling components may be defined herein as removal of low boiling components to give a concentrated silica dispersion containing from about 15 weight percent to about 80 weight percent silica.

B-staging of the curable resin (in the case of a single-resin composition) or the first resin composition (in the case of a composition comprising two resins) occurs at a temperature in a range of from about 50 degrees Celsius to about 250 degrees Celsius, more in a range of from about 70 degrees Celsius to about 100 degrees Celsius, in a vacuum at a pressure ranging of from about 25 mmHg to about 250 mmHg, or in a range of from about 100 mmHg to about 200 mmHg. In addition, B-staging may occur over a period of time ranging from about 30 minutes to about 5 hours, and more in a range of from about 45 minutes to about 2.5 hours. Optionally, the B-staged resins may be post-cured at a temperature in a range of from about 100 degrees Celsius to about 250 degrees Celsius, more in range of from about 150 degrees Celsius to about 200 degrees Celsius over a period of time ranging from about 45 minutes to about 3 hours.

The resulting curable resin or first resin composition (of a two-resin composition) contains functionalized silicon dioxide as the functionalized colloidal silica. In such a case, the amount of silicon dioxide in the final composition may range from about 15 weight percent to about 80 weight percent of the final composition, from about 25 weight percent to about 75 weight percent, or from about 30 weight percent to about 70 weight percent of the final cured resin composition. The colloidal silica filler may be uniformly distributed throughout the disclosed composition, and this distribution remains stable at room temperature. As used herein “uniformly distributed” means the absence of any visible precipitate with such dispersions being transparent.

In some instances, the pre-dispersion or the final dispersion of the functionalized colloidal silica may be further functionalized. Low boiling components may be at least partially removed and subsequently, an appropriate capping agent that will react with residual hydroxyl functionality of the functionalized colloidal silica may be added in an amount in a range of from about 0.05 times to about 10 times the amount of silicon dioxide present in the pre-dispersion or final dispersion. Partial removal of low boiling components may remove at least about 10 weight percent of the total amount of low boiling point components, an amount of low boiling point components in a range of from about 10 weight percent to about 50 weight percent, or greater than about 50 weight percent of the total amount of low boiling point components.

An effective amount of capping agent caps the functionalized colloidal silica and capped functionalized colloidal silica may be defined herein as a functionalized colloidal silica in which at least 10 weight percent, at least 20 weight percent, at least 35 weight percent, of the free hydroxyl groups present in the corresponding uncapped functionalized colloidal silica have been functionalized by reaction with a capping agent.

In some cases, capping the functionalized colloidal silica effectively improves the cure of the total curable resin formulation by improving room temperature stability of the resin formulation. Formulations which may include the capped functionalized colloidal silica show much better room temperature stability than analogous formulations in which the colloidal silica has not been capped in some cases.

Capping agents may include hydroxyl reactive materials such as silylating agents. Examples of a silylating agent may include one or more of hexamethyl disilazane (“HMDZ”), tetramethyl disilazane, divinyl tetramethyl disilazane, diphenyl tetramethyl disilazane, N-(trimethylsilyl) diethylamine, 1-(trimethyl silyl) imidazole, trimethyl chlorosilane, pentamethyl chloro disiloxane, pentamethyl disiloxane, and the like. In one embodiment, hexamethyl disilazane may be used as the capping agent. Where the dispersion has been further functionalized, e.g. by capping, at least one curable monomer may be added to form the final dispersion. The dispersion may be then heated in a range of from about 20 degrees Celsius to about 140 degrees Celsius for a period of time in a range of from about 0.5 hours to about 48 hours. The resultant mixture may be then filtered. The mixture of the functionalized colloidal silica in the curable monomer may be concentrated at a pressure in a range of from about 0.5 Torr to about 250 Torr to form the final concentrated dispersion. During this process, lower boiling components such as solvent, residual water, byproducts of the capping agent and hydroxyl groups, excess capping agent, and combinations thereof may be substantially removed to give a dispersion of capped functionalized colloidal silica containing from about 15 weight percent to about 75 weight percent silica.

Optionally, an epoxy hardener such as an amine epoxy hardener, a phenolic resin, a hydroxy aromatic compound, a carboxylic acid-anhydride, or a novolac hardener may be added. In some embodiments, a difunctional siloxane anhydride may be used as an epoxy hardener, optionally in combination with at least one of the foregoing hardeners. Additionally, cure catalysts or organic compounds containing hydroxyl moiety may be optionally added with the epoxy hardener.

Exemplary amine epoxy hardeners may include aromatic amines, aliphatic amines, or combinations thereof. Aromatic amines may include, for example, m-phenylene diamine, 4,4′-methylenedianiline, diaminodiphenylsulfone, diaminodiphenyl ether, toluene diamine, dianisidene, and blends of amines. Aliphatic amines may include, for example, ethyleneamines, cyclohexyldiamines, alkyl substituted diamines, menthane diamine, isophorone diamine, and hydrogenated versions of the aromatic diamines. Combinations of amine epoxy hardeners may also be used. Illustrative examples of amine epoxy hardeners may be also described in “Chemistry and Technology of the Epoxy Resins” B. Ellis (Ed.) Chapman Hall, New York, 1993.

Exemplary phenolic resins may include phenol-formaldehyde condensation products, commonly named novolac or cresol resins. These resins may be condensation products of different phenols with various molar ratios of formaldehyde. Such novolac resin hardeners may include those commercially available such as TAMANOL 758 or HRJ1583 oligomeric resins available from Arakawa Chemical Industries and Schenectady International, respectively. Additional examples of phenolic resin hardeners may be also described in “Chemistry and Technology of the Epoxy Resins” B. Ellis (Ed.) Chapman Hall, New York, 1993. While these materials may be representative of additives used to promote curing of the epoxy formulations, it will apparent to those skilled in the art that other materials such as amino formaldehyde resins may be used as hardeners and thus fall within the scope of this disclosure.

Suitable hydroxy aromatic compounds may be those that do not interfere with the resin matrix of the present composition. Such hydroxy-containing monomers may include hydroxy aromatic compounds represented by the following formula: 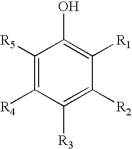
wherein R1 to R5, may be independently a C₁-C₁₀ branched or chain aliphatic or aromatic group, or hydroxyl. Examples of such hydroxyl aromatic compounds may include, but may be not limited to, hydroquinone, resorcinol, catechol, methyl hydroquinone, methyl resorcinol and methyl catechol. If present, the hydroxy aromatic compounds may be present in an amount of from about 0.3 weight percent to about 15 weight percent, or about 0.5 to about 10 weight percent.

Exemplary anhydride curing agents may include methylhexahydrophthalic anhydride (“MHHPA”), methyltetrahydrophthalic anhydride, 1,2-cyclohexanedicarboxylic anhydride, bicyclo[2.2.1]hept-5-ene-2,3-dicarboxylic anhydride, methylbicyclo[2.2.1]hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, and the like. Combinations comprising at least two anhydride curing agents may also be used. Illustrative examples may be described in “Chemistry and Technology of the Epoxy Resins”; B. Ellis (Ed.) Chapman Hall, New York, (1993) and in “Epoxy Resins Chemistry and Technology”; edited by C. A. May, Marcel Dekker, New York, 2nd edition, (1988).

Exemplary difunctional siloxane anhydrides and methods for their production may be known to those skilled in the art and may include, for example, the anhydrides disclosed in U.S. Pat. Nos. 4,542,226 and 4,381,396. Suitable anhydrides may include those of the following formula: 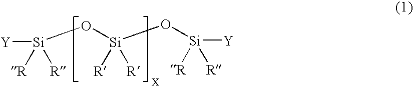
where X may be from 0 to 50 inclusive, X may be from 0 to 10 inclusive, or X may be from 1 to 6 inclusive; where each R′ and R″ may be independently at each occurrence C₁₋₂₂ alkyl, C₁₋₂₂ alkoxy, C₂₋₂₂ alkenyl, C₆₋₁₄ aryl, C₆₋₂₂ alkyl-substituted aryl, and C₆₋₂₂ arylalkyl; and where Y may be represented by the following formula: 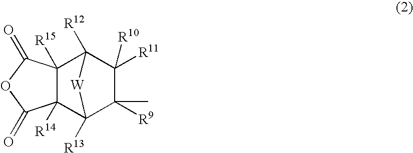
where R⁹-R¹⁵ may be a members selected from hydrogen, halogen, C₍₁₋₁₃₎ monovalent hydrocarbon radicals and substituted C₍₁₋₁₃₎ monovalent hydrocarbon radicals, and W may be selected from —O— and CR₂—, wherein R has the same definition as R⁹-R¹⁵.

In some embodiments the R′ and R″ may be halogenated, for example fluorinated, to provide fluorocarbons such as C₁₋₂₂ fluoroalkyl. R′ and R″ may be methyl, ethyl, 3,3,3-trifluoropropyl or phenyl, R′ and R″ may both be methyl. The difunctional siloxane anhydride utilized in the disclosure as an epoxy hardener may be a single compound or a mixture of oligomers with different lengths of siloxane chain which may be terminated with the Y moiety.

A suitable difunctional siloxane anhydride may have the following structural formula: 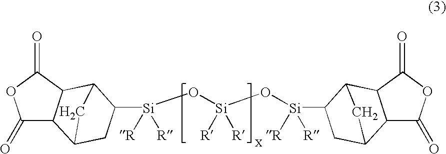
where X, R′ and R″ may be as defined above in formula (1), i.e., X may be from 0 to 50 inclusive, X may be from 0 to 10 inclusive, or X may be from 1 to 6 inclusive; and each R′ and R″ may be independently at each occurrence C1-22 alkyl, C1-22 alkoxy, C2-22 alkenyl, C6-14 aryl, C6-22 alkyl-substituted aryl, and C6-22 arylalkyl. In some embodiments the R′ and R″ may be halogenated, for example fluorinated, to provide fluorocarbons such as C₁₋₂₂ fluoroalkyl. R′ and R″ may be methyl, ethyl, 3,3,3-trifluoropropyl, phenyl, or methyl. As described above, a single compound may be used or a mixture of oligomers with different lengths of siloxane chain may be used.

In one embodiment, the oligosiloxane dianhydride of the disclosure may be synthesized by hydrosilation of 1 mol 1,1,3,3,5,5-hexamethyltrisiloxane with two moles of 5-norbornene-2,3-dicarboxylic anhydride in the presence of Karstedt's platinum catalyst (the complex of Pt⁰ with divinyltetramethyldisiloxane described in U.S. Pat. No. 3,775,442). In one embodiment, 5,5′-(1,1,3,3,5,5-hexamethyl-1,5,trisiloxanediyl)bis[hexahydro-4,7-methanoisobenzofuran-1,3-dione] may be used as the difunctional siloxane anhydride.

Cure catalysts which may be added to form the epoxy formulation may be selected from typical epoxy curing catalysts that may include but may be not limited to amines, alkyl-substituted imidazole, imidazolium salts, phosphines, metal salts such as aluminum acetyl acetonate (Al(acac)3), salts of nitrogen-containing compounds with acidic compounds, and combinations thereof. The nitrogen-containing compounds may include, for example, amine compounds, di-aza compounds, tri-aza compounds, polyamine compounds and combinations thereof. The acidic compounds may include phenol, organo-substituted phenols, carboxylic acids, sulfonic acids and combinations thereof. A suitable catalyst may be a salt of nitrogen-containing compounds. Salts of nitrogen-containing compounds may include, for example 1,8-diazabicyclo(5,4,0)-7-undecane. The salts of the nitrogen-containing compounds may be available commercially, for example, as Polycat SA-1 and Polycat SA-102 available from Air Products. A catalyst may include one or more of triphenyl phosphine (TPP), N-methylimidazole (NMI), and dibutyl tin dilaurate (DiBSn).

Examples of organic compounds utilized as the hydroxyl-containing moiety may include alcohols such as diols, high boiling alkyl alcohols containing one or more hydroxyl groups and bisphenols. The alkyl alcohols may be straight chain, branched or cycloaliphatic and may contain from 2 to 12 carbon atoms. Examples of such alcohols may include but may be not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and combinations of any of the foregoing. Further examples of alcohols may include 3-ethyl-3-hydroxymethyl-oxetane (commercially available as UVR6000 from Dow Chemicals and bisphenols.

Suitable dihydroxy-substituted aromatic compounds may include 4,4′-(3,3,5-trimethylcyclohexylidene)-diphenol; 2,2-bis(4-hydroxyphenyl)propane (commonly known as bisphenol A); 2,2-bis(4-hydroxyphenyl)methane (commonly known as bisphenol F); 2,2-bis(4-hydroxy-3,5-dimethylphenyl)propane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl ethane; 2,2-bis(3-phenyl-4-hydroxyphenyl)propane; bis(4-hydroxyphenyl)cyclohexylmethane; 2,2-bis(4-hydroxyphenyl)-1-phenylpropane; 2,2,2′,2′-tetrahydro-3,3,3′,3′-tetramethyl, 1′-spirobi{1H-indene}-6,6′-diol (“SBI”); 2,2-bis(4-hydroxy-3-methylphenyl)propane (commonly known as “DMBPC”); and C₁₋₁₃ alkyl-substituted resorcinols. Most typically, 2,2-bis(4-hydroxyphenyl)propane and 2,2-bis(4-hydroxyphenyl)methane may be bisphenol compounds. Combinations of organic compounds containing hydroxyl moiety may also be used in the disclosure.

A reactive organic diluent may also be added to the total curable epoxy formulation to decrease the viscosity of the composition. Examples of reactive diluents may include, but may be not limited to, 3-ethyl-3-hydroxymethyl-oxetane, dodecylglycidyl ether, 4-vinyl-1-cyclohexane diepoxide, di(beta-(3,4-epoxycyclohexyl)ethyl)-tetramethyldisiloxane, and combinations thereof. Reactive organic diluents may include monofunctional epoxies and/or compounds containing at least one epoxy functionality. Representative examples of such diluents may include, but may be not limited to, alkyl derivatives of phenol glycidyl ethers such as 3-(2-nonylphenyloxy)-1,2-epoxypropane or 3-(4-nonylphenyloxy)-1,2-epoxypropane. Other diluents which may be used may include glycidyl ethers of phenol itself and substituted phenols such as 2-methylphenol, 4-methyl phenol, 3-methylphenol, 2-butylphenol, 4-butylphenol, 3-octylphenol, 4-octylphenol, 4-t-butylphenol, 4-phenylphenol and 4-(phenylisopropylidene)phenol.

Adhesion promoters may also be employed with the first curable resin such as trialkoxyorganosilanes (e.g., γ-aminopropyltrimethoxysilane, 3-glycidoxypropyltrimethoxysilane, and bis(trimethoxysilylpropyl)fumarate). Where present, the adhesion promoters may be added in an effective amount which may be in a range of from about 0.01 weight percent to about 2 weight percent of the total final dispersion.

Optionally, micron size fused silica filler may be added to the resins. Where present, the fused silica fillers may be added in an effective amount to provide further reduction in CTE.

Flame retardants may be optionally used in the first curable resin in a range of from about 0.5 weight percent to about 20 weight percent relative to the amount of the total final dispersion. Examples of flame retardants may include phosphoramides, triphenyl phosphate (TPP), resorcinol diphosphate (RDP), bisphenol-a-disphosphate (BPA-DP), organic phosphine oxides, halogenated epoxy resin (tetrabromobisphenol A), metal oxide, metal hydroxides, and combinations of two or more thereof.

In addition to the epoxy resin matrix described, two or more epoxy resins may be used in combination for the aromatic epoxy resin of the first curable resin e.g., a mixture of an alicyclic epoxy and an aromatic epoxy. Such a combination improves transparency and flow properties. An epoxy mixture may include at least one epoxy resin having three or more functionalities, to thereby form an underfill resin having low CTE, good fluxing performance, and a high glass transition temperature. The epoxy resin may include a trifunctional epoxy resin, in addition to at least a difunctional alicyclic epoxy and a difunctional aromatic epoxy.

In an embodiment of the invention wherein the composition comprises a combination of two resins, the second curable fluxing resin composition may include a resin matrix of at least one epoxy resin. The epoxy resin of the second fluxing composition may be any epoxy resin described above as suitable for use in the first solvent-modified resin, or combinations thereof. The second curable fluxing resin may include any epoxy hardener described above, as well as any catalyst, hydroxyl-containing moiety, reactive organic diluent, adhesion promoter, flame retardant, or combinations thereof as described above as suitable for use with the solvent-modified resin.

In some embodiments, where utilized, aliphatic epoxy monomers may be may included in the resin component of the second fluxing resin composition in amounts ranging from about 1 weight percent to about 50 weight percent of the resin component of the second fluxing composition, or in a range of from about 5 weight percent to about 25 weight percent.

In some embodiments, where utilized, cycloaliphatic epoxy monomers may be may included in the resin component of the second fluxing resin composition in amounts ranging from about 1 weight percent to about 100 weight percent of the resin component of the second fluxing composition, or in a range of from about 25 weight percent to about 75 weight percent.

In some embodiments, where utilized, aromatic epoxy monomers may be may included in the resin component of the second fluxing resin composition in amounts ranging from about 1 weight percent to about 100 weight percent of the resin component of the second fluxing composition, or in a range of from about 25 weight percent to about 75 weight percent.

In one embodiment the epoxy resin may be a combination of 3-cyclohexenylmethyl-3-cyclohexenylcarboxylate diepoxide (commercially available as UVR 6105 from Dow Chemical Co.), and bisphenol-F epoxy resin (commercially available as RSL-1739 from Resolution Performance Product). In another embodiment, a suitable epoxy resin may include a combination of 3-cyclohexenylmethyl-3-cyclohexenylcarboxylate diepoxide and bisphenol-A epoxy resin (commercially available as RSL-1462 from Resolution Performance Product). Combinations of the foregoing may also be used.

In one embodiment, the second curable fluxing resin may include a difunctional siloxane anhydride as described above which, in some cases, may be combined with another epoxy hardener such as an amine epoxy hardener, a phenolic resin, a carboxylic acid-anhydride, or a novolac hardener as described above. In some embodiments, the difunctional siloxane anhydride of the disclosure may be miscible with liquid carboxylic acid-anhydrides. The difunctional siloxane anhydride may thus be blended with a carboxylic acid-anhydride to form a liquid solution. In these embodiments, the epoxy hardener may include a difunctional siloxane anhydride in combination with a liquid organic anhydride such as hexahydrophthalic anhydride, MHHPA, or tetrahydrophthalic anhydride.

Where utilized, the difunctional siloxane anhydrides may be may included in the hardener component of the second curable fluxing resin composition in amounts ranging from about 1 weight percent to about 100 weight percent of the hardener component of the second curable fluxing resin composition. The component may be present in an amount in a range of from about 10 weight percent to about 40 weight percent, or from about 40 weight percent to about 90 weight percent.

Where utilized, the carboxylic acid-anhydrides may be may included in the hardener component of the second curable fluxing resin composition in amounts ranging from about 1 weight percent to about 95 weight percent of the hardener component of the composition, with a range of from about 10 weight percent to about 90 weight percent being, or in a range of from about 60 weight percent to about 90 weight percent.

Examples of the second fluxing resin may include combinations of 3-cyclohexenylmethyl-3-cyclohexenylcarboxylate diepoxide (commercially available as UVR 6105 from Dow Chemical Co.), bisphenol-F epoxy resin (including RSL-1739 which may be commercially available from Resolution Performance Product), MHHPA, catalysts including salts of nitrogen-containing compounds such as Polycat SA-1 (from Air Products), and organic compounds having a hydroxyl-containing moiety such as 3-ethyl-3-hydroxy methyl oxetane, (commercially available as UVR 6000 from Dow Chemical Co.). In some embodiments, a bisphenol-A epoxy resin (such as RSL-1462 from Resolution Performance Product) may be used in place of the bisphenol-F resin. In other embodiments, an additional difunctional siloxane anhydride epoxy hardener, such as 5,5′-(1,1,3,3,5,5-hexamethyl-1,5,trisiloxanediyl)bis[hexahydro-4,7-methanoisobenzofuran-1,3-dione] (TriSDA) may be may included. Where a bisphenol epoxy resin may be utilized, the bisphenol resin may be present in the epoxy component of the second fluxing resin in an amount ranging from about 1 weight percent to 100 weight percent of the resin composition, or in a range of from about 25 weight percent to about 75 weight percent.

The second curable fluxing resin composition may be a liquid having a viscosity ranging from about 50 centipoise to about 100,000 centipoise, or in a range of from about 1000 centipoise to about 20,000 centipoise at 25 degrees Celsius before the composition may be cured. The second fluxing resin may optionally be combined with a particle filler dispersion which, in one embodiment, comprises at least one colloidal silica functionalized with an organoalkoxysilane as described above having a particle size in a range of from about 1 nanometers to about 500 nm, and more in a range of from about 5 nanometers to about 200 nm.

Methods for producing the compositions of the disclosure result in improved underfill materials. For the first solvent-modified resin composition, in one embodiment compositions may be prepared by functionalizing colloidal silica such that a stable concentrated dispersion of colloidal silica may be formed; forming a concentrated dispersion of functionalized colloidal silica containing about 15 weight percent to about 75 weight percent silica; blending solutions of epoxy monomers including at least aromatic epoxy resin optionally in combination with cycloaliphatic epoxy monomers, aliphatic epoxy monomers, and/or hydroxy aromatic compounds, and optionally one or more additives such as hardeners, catalysts or other additives described above, and at least one solvent with the functionalized colloidal silica dispersion; and removing the solvent to form a hard, transparent B-stage resin film.

The second curable fluxing resin composition may be similarly prepared. In one embodiment, second curable fluxing resin compositions may be prepared by blending solutions of epoxy monomers and optionally one or more additives such as hardeners, catalysts or other additives described above. In some cases, the second fluxing resin may include a functionalized colloidal silica dispersion as a filler and may be prepared in the same manner as the functionalized colloidal silica dispersion utilized in the first solvent-modified resin. In other embodiments, the second fluxing resin does not may include a functionalized colloidal silica dispersion as a filler.

Curing the B-stage resin film in combination with the second fluxing resin may be useful in forming a low CTE, high glass transition temperature thermoset resin for use as an underfill material.

A first resin composition of the disclosure may be applied as wafer level underfill. The wafer level underfilling process may include dispensing underfill materials onto the wafer, followed by removal of solvent to form a solid, transparent B-stage resin before dicing into individual chips that may be subsequently mounted in the final structure via flip-chip type operations.

The second curable fluxing resin may be then applied to a substrate as a no-flow underfill. The process generally may include first dispensing the second resin material onto a substrate or semiconductor device, placing a flip chip coated with the solvent-modified resin of the disclosure on top of the fluxing resin, and then performing a solder bump reflow operation to simultaneously form solder joints and cure the two resin compositions which make up the underfill material. The combined resins thus act as an encapsulant material between chip and substrate.

Two resin compositions of the disclosure may be utilized as follows. The first solvent-modified resin may be applied to a wafer or chip and cured as described above to form a B-stage resin. If the first solvent-modified resin has been applied as wafer level underfill, it may be subjected to dicing or a similar operation after formation of the B-stage resin to produce individual chips.

Once the chips have been prepared, the second fluxing resin may be applied to a substrate. Methods for applying the second fluxing resin may be known to those skilled in the art and may include dispensing with a needle and printing. The second fluxing resin of the disclosure may be dispensed using a needle in a dot pattern in the center of a component footprint area. The amount of second fluxing resin may be carefully controlled to avoid the phenomenon known as “chip-floating”, which results from dispensing an excess of the fluxing resin. The flip-chip die coated with the solvent-modified resin that has been B-staged may be placed on top of the dispensed second fluxing resin using an automatic pick and place machine. The placement force as well as the placement head dwell time may be controlled to optimize cycle time and yield of the process.

The construction may be then heated to melt solder balls, form solder interconnects and cure the B-stage resin in combination with the fluxing resin. The heating operation usually may be performed on the conveyor in the reflow oven. The underfill may be cured by two significantly different reflow profiles. The first profile may be referred to as the “plateau” profile, which may include a soak zone below the melting point of the solder. The second profile, referred to as the “volcano” profile, raises the temperature at a constant heating rate until the maximum temperature may be reached. A temperature ceiling during a cure cycle may be in a range of from about 200 degrees Celsius to about 260 degrees Celsius.

The temperature during the reflow may depend on solder composition and may be about 10 degrees Celsius to about 40 degrees Celsius higher than the melting point of the solder balls. The heating cycle may be of from about 3 minutes to about 10 minutes, and more may be from about 4 minutes to about 6 minutes. The underfill may cure completely after the solder joints may be formed or may require additional post-cure. Optionally, post-curing may occur at a temperature ranging from about 100 degrees Celsius to about 140 degrees Celsius, from about 140 degrees Celsius to a bout 160 degrees Celsius, from about 160 degrees Celsius to about 180 degrees Celsius, or greater than about 180 degrees Celsius, for less than about 1 hour, or over a period ranging from about 1 hour to about 4 hours.

Thus, the use of a first solvent-modified epoxy resin may be useful in producing B-stage resin films, and once combined with a second fluxing resin, curing the combination of the two resins may be useful to produce low CTE, high glass transition temperature thermoset resins. The transparency of the B-stage resin films formed from the first solvent-modified resin of the disclosure makes them especially suitable as wafer level underfill materials as they do not obscure guide marks used for wafer dicing.

The second fluxing resin advantageously holds the chip to which the first solvent-modified resin has been applied in place during reflow operations. Moreover, by following the methods of the disclosure, where the second fluxing resin may be unfilled, one may obtain a graded underfill material with the CTE of the material decreasing from the substrate to the chip.

It has been surprisingly found that by following the methods of the disclosure, one may obtain underfill materials having elevated levels of functionalized colloidal silica that may be not otherwise obtainable by current methods. In addition, the B-stage resin films in combination with the second fluxing resin may provide good electrical connections during solder reflow operations resulting in low CTE, high glass transition temperature thermoset resins after curing.

Underfill materials may be dispensable and have utility in devices such as solid-state devices and/or electronic devices such as computers or semiconductors, or a device where underfill, overmold, or combinations thereof may be needed. The underfill material may be used as an adhesive, for example, to reinforce physical, mechanical, and electrical properties of solder bumps that connect a chip and a substrate. Underfill materials may exhibit enhanced performance, may have economic advantages, and may permit formation of solder joints before the underfill materials reach a gel point and then forming a solid encapsulant. An adhesive composition may fill gaps having a depth ranging from about 30 nanometers to about 500 micrometers. In one embodiment, a coefficient of thermal expansion of a cured adhesive composition may be below about 50 parts per million per degree centigrade (ppm/C).

In one embodiment, an uncured underfill composition may have a low viscosity. Low viscosity of the total composition before cure refers to a viscosity of the underfill material in a range of from about 50 centipoise to about 100,000 centipoise, or in a range of from about 1000 centipoise to about 20,000 centipoise at about room temperature before the composition may be cured. Viscosity may be measured by a Brookfield viscometer or the like.

In one embodiment, a finely divided refractory solid may have a surface area that is greater than about 5 square meters per gram, and a density of active surface termination sites per square nanometer of surface area sufficiently low that a curable resin that contains less than about 99 percent by weight of the solid has a stability ratio of less than about 3 after a period of about two weeks.

Stability, as used herein in the specification and claims, refers to the ratio of viscosity of a mixture of the solid and the curable resin measured initially after mixing, and measured again after a period of time, e.g., one week, two weeks, and the like.

Suitable solids may have a surface area greater than about 20 square meters per gram, greater than about 60 square meters per gram, or greater than about 150 square meters per gram. The solid may include a plurality of nano-particles having an average diameter in a range of from about 1 nanometer to about 100 nanometers. The nano-particles have one or more of a spherical, amorphous or geometric morphology. In one embodiment, the nano-particles may be amorphous. Suitable nano-particles may be porous, non-porous, or a combination thereof. The pores may be uniform or may be randomly shaped and/or sized.

A suitable solid may include one or more metal or metalloid. In one embodiment, the solid may include aluminum, antimony, arsenic, beryllium, boron, carbon, chromium, copper, gallium, gold, germanium, indium, iron, hafnium, magnesium, manganese, molybdenum, phosphorous, silicon, silver, titanium, tungsten, or zirconium, or the like, or an alloy of two or more thereof. In one embodiment, the solid may include one or more of arsenic, aluminum, boron, gallium, germanium, silicon, titanium, or an oxide or nitride thereof, such as alumina, silica, titania, boronitride, and the like.

A suitable solid oxide may include silicon oxide, and the active surface termination site comprises a silanol group. Another suitable solid oxide may include aluminum oxide (alumina) and the active surface termination site may include a hydroxyl group. A suitable solid nitride may have the active surface termination site include an amide or an imide.

In one embodiment, the density of active termination sites is controlled to be about 6 or less, about 5 or less, about 4.75 or less, or in a range of from about 10 to about 1, from about 5 to about 3, or from about 4.5 to about 4.0. A suitable stability ratio, as the ratio of viscosity (two weeks/initial), may be less than about 5, less than about 4, less than about 3 less than about 2, or about 1.

As noted hereinabove, passivating or capping active termination sites may be accomplished by, for example, a sequential treatment. A first portion of active surface termination sites may be reacted with a functionalizing composition or a compatiblizing composition. A suitable functionalizing composition may include those disclosed hereinabove, such as an alkoxysilane having an organic moiety that may be one or more of acrylate, alkyl, phenyl, cyclohexyloxy, or glycidyl. Of the remaining active termination sites, a second portion may be reacted with a passivating composition, such as a silazane or other capping agent as disclosed herein.

The refractory solid may be added to a curable resin to form an adhesive system. A suitable curable resin may include a resin as disclosed herein, such as one or more of an acrylic, urethane, isocyanate, cyanate ester, imide, or epoxy resin. The resins may be multi-functional, for example, the epoxy resin may be multi-functional.

Naturally, as with most adhesive systems, the curable resin may include one or more additive. Suitable additives may be selected with reference to performance requirements for particular applications. For example, a fire retardant additive may be selected where fire retardancy is desired, a flow modifier may be employed to affect rheology or thixotropy, a thermally conductive material may be added where thermal conductivity is desired, and the like.

A suitable amount of solid in the adhesive system may be greater than about 1 weight percent or less than about 99 weight percent. In one embodiment, the solid may be present in an amount sufficient to about match a coefficient of thermal expansion of the adhesive composition to a chip selected for use with the adhesive system. In one embodiment, the solid may be present in the adhesive system in a range of from about 5 weight percent to about 25 weight percent, from about 25 weight percent to about 35 weight percent, from about 35 weight percent, to about 45 weight percent, from about 45 weight percent to about 55 weight percent, from about 55 weight percent to about 65 weight percent, or greater than about 65 weight percent.

Because of factors, such as filler amount, the coefficient of thermal expansion of the adhesive composition, after cure, may be selected to be less than about 50 ppm/degree Celsius, less than about 40 ppm/degree Celsius, or less than about 30 ppm/degree Celsius. In one embodiment, the coefficient of thermal expansion may be in a range of from about 10 ppm/degree Celsius to about 20 ppm/degree Celsius, from about 20 ppm/degree Celsius to about 30 ppm/degree Celsius, from about 30 ppm/degree Celsius to about 40 ppm/degree Celsius, or greater than about 40 ppm/degree Celsius. In one embodiment, a glass transition temperature of the adhesive composition, after cure, may be greater than about 150 degrees Celsius, greater than about 200 degrees Celsius, greater than about 250 degrees Celsius, greater than about 300 degrees Celsius, or greater than about 350 degrees Celsius.

An electronic device may be formed by assembling a chip to a substrate using the adhesive composition. A suitable chip may include a semiconductor material, such as silicon, gallium, germanium or indium, or combinations of two or more thereof. Should the assembly be amenable, the adhesive composition may be used as an underfill material.

A filled resin system according to embodiments of the invention may be produced by reacting a first portion of active termination sites of a plurality of particles with a functionalizing composition; and reacting a second portion of active termination sites of the plurality of particles with a passivating composition. Reacting the second portion of active termination sites may include capping or passivating active termination sites on a surface of each particle of the plurality to achieve less than about 10 active termination sites per square nanometer of surface area to stabilize the resin system. In one embodiment, the number of residual active termination sites may be less than about 6, less than about 5, less than about 4, or less than about 3.

The number of active termination sites remaining may be determined by the selection of filler material, the surface properties and any pretreatments of the filler material, the particle size of the filler material, the functionalizing or compatiblizing agent used, the passivating or capping agent used, the reaction parameters (length, temperature, pressure, and the like), and combinations of two or more thereof.

In one embodiment, the filler material may be prepared by capping or passivating prior to removal of a low boiling point solvent or fluid component. The low boiling point solvent or fluid component may be removed, at least partially, subsequent to the step of capping or passivating. In another embodiment, a refractory solid used as a filler material in a curable resin composition or adhesive system may have a relatively high stability or shelf life at a temperature that is greater than room temperature, for example, at a temperature in a range of from about 30 degrees Celsius to about 50 degrees Celsius, 50 degrees Celsius to about 75 degrees Celsius, 75 degrees Celsius to about 100 degrees Celsius, or greater than about 100 degrees Celsius.

### EXAMPLES

The following examples may be intended only to illustrate methods and embodiments in accordance with the invention, and as such should not be construed as imposing limitations upon the claims. Unless specified otherwise, all ingredients may be commercially available from such common chemical suppliers as Alpha Aesar, Inc. (Ward Hill, Mass.), Spectrum Chemical Mfg. Corp. (Gardena, Calif.), and the like.

### Example 1

Preparation of functionalized colloidal silica (FCS) predispersion. A functionalized colloidal silica predispersion is prepared by combining the following: 935 grams of isopropanol is slowly added by stirring to 675 grams of aqueous colloidal silica containing 34 weight percent of 20 nanometer diameter particles of SiO₂. Subsequently, 58.5 grams phenyl trimethoxysilane (PTS) is dissolved in 100 grams isopropanol, is added to the stirred mixture. The mixture is then heated to 80 degrees Celsius for 1-2 hours to afford a clear suspension. The resulting suspension of functionalized colloidal silica is stored at room temperature. Multiple dispersions, having various levels of SiO₂ (from 10 weight percent to 30 weight percent) are prepared for use in Example 2.

### Example 2

Preparation of dispersion of a functionalized colloidal silica in epoxy resin. A round bottom 2000 ml flask is charged with 540 grams of each of the pre-dispersions, prepared in Example 1. Additional pre-dispersion compositions may be shown in Table 1, below. 1-methoxy-2-propanol (750 grams) is then added to each flask. The resulting dispersion of functionalized colloidal silica is vacuum stripped at 60 degrees Celsius and 60 mmHg to remove about 1 liter (L) of solvent. The vacuum is slowly decreased and solvent removal continued with good agitation until the dispersion weight had reached 140 g. The clear dispersion of phenyl-functionalized colloidal silica contained 50 weight percent SiO₂ and no precipitated silica. This dispersion is stable at room temperature for more than three months. The results in Table 1 show that a certain level of phenyl functionality may be required in order to prepare a concentrated, stable FCS dispersion in 1-methoxy-2-propanol (Dispersion 1 through 5). The functionality level may be adjusted to achieve a clear, stable dispersion in methoxypropanol acetate. This adjustment indicated that optimization of functionality level permitted dispersions to be prepared in other solvents (Dispersions 6 and 7).

TABLE 1
Preparation of FCS Dispersions

| | | Final Dispersion | |
|---|---|---|---|
| | Pre-dispersion | Concentration | |
| | Composition | (weight percent SiO₂)/ | |
| | (PTS*/100 g | (weight percent | |
| Entry# | SiO2) | total solids) | Dispersion Stability |
| | | | (in methoxypropanol) |
| 1 | 0.028 m/100 g | 50/63 | Precipitated |
| 2 | 0.056 m/100 g | 47/60 | Precipitated |
| 3 | 0.13 m/100 g | 53/66 | stable, clear |
| 4 | 0.13 m/100 g | 60/75 | stable, clear |
| 5 | 0.19 m/100 g | 50/63 | stable, clear |
| | | (in methoxy propanol acetate) | |
| 6 | 0.13 m/100 g | 50/63 | Precipitated |
| 7 | 0.19 m/100 g | 50/63 | stable, clear |

*PTS is phenyltrimethoxysilane

### Example 3

Preparation of a dispersion of capped functionalized colloidal silica in epoxy resin. A solution combining 5.33 grams of epoxy cresol novolac (ECN 195XL-25 available from Sumitomo Chemical Co.), 2.6 grams of novolac hardener (TAMANOL 758 available from Arakawa Chemical Industries) in 3.0 grams of 1-methoxy-2-propanol is heated to about 50 degrees Celsius. A 7.28 grams portion of the solution is added, dropwise, to 10.0 grams of the FCS dispersion, by stirring at 50 degrees Celsius (see, Table 1, entry #3, 50 weight percent SiO₂ in methoxypropanol, above). The clear suspension is cooled and a catalyst solution of N-methylimidazole, 60 microliters of a 50 weight percent (w/w) solution in methoxypropanol is added by stirring. The clear solution is used directly to cast resin films for characterization or stored at −10 degrees Celsius. Additional films are prepared using differing catalysts in various amounts and some variations in the epoxy as set forth in Table 2 below which shows final resin compositions.

Films are cast by spreading a portion of the epoxy-silica dispersion on glass plates, and the solvent is removed in an oven set at 85 degrees Celsius under a vacuum of 150 mmHg. After 1-2 hours, the glass plates are removed and the film remaining is clear and hard. In some cases, the dry film is cured at 220 degrees Celsius for 5 minutes followed by heating at 160 degrees Celsius for 60 minutes. Glass transition temperature measurements are obtained by Differential Scanning Calorimetry using a commercially available DSC from Perkin Elmer. The formulations tested and their glass transition temperature may be set forth below in Table 2.

TABLE 2
Colloidal Silica Formulations

| | | | Solvent*** | Catalyst**** | FCS | |
|---|---|---|---|---|---|---|
| Entry # | Epoxy (g)* | Hardener**(g) | (g) | (g) | amount***** | Tg****** |
| 1 | ECN (3.55) | T758 (1.73) | MeOPrOH(2) | TPP (0.12) | 10 | 168 |
| 2 | ECN (3.55) | T758 (1.73) | MeOPrOH(2) | TPP (0.06) | 10 | 165 |
| 3 | ECN (3.55) | T758 (1.73) | MeOPrOH(2) | NMI (0.015) | 10 | 199 |
| 4 | ECN (3.55) | T758 (1.73) | MeOPrOH(2) | NMI (0.018) | 5 | 180 |
| 5 | ECN (3.55) | T758 (1.73) | MeOPrOH(2) | TPP (0.06) | 10 | 136 |
| | Epon 1002F | | | | | |
| | (0.5) | | | | | |
| 6 | ECN (3.55) | T758 (1.73) | MeOPrOH(2) | NMI (0.03) | 10 | 184 |
| | Epon 1002F | | | | | |
| | (0.5) | | | | | |
| 7 | ECN (3.55) | T758 (1.73) | BuAc(2) | TPP (0.12) | 5 | 171 |
| 8 | ECN (3.55) | T758 (1.73) | diglyme(2) | TPP (0.12) | 5 | 171 |
| 9 | ECN (3.55) | T758 (1.73) | BuAc(2) | DiBSn | 5 | 104 |
| | | | | (0.12) | | |

*ECN refers to ECN 195XL-25 available form Sumitomo Chemical Co. and Epon 1002F refers to an oligomerized BPA diglycidyl ether epoxy available from Resolution Performance Products.
**T758 refers to TAMANOL 758 available from Arakawa Chemical Industries
***Solvents may be 1-methoxy-2-propanol(MeOPrOH), butyl acetate (BuAc) or methoxyethyl ether (diglyme)
****Catalysts may be triphenyl phosphine (TPP), N-methylimidazole (NMI) or dibutyl tin dilaurate (DiBSn)
*****FCS amount refers to the amount in grams of 50 weight percent SiO₂ phenyl functionalized colloidal silica described in Example 2.
******glass transition temperature refers to the glass transition temperature as measured by DSC (mid-point of inflection).

### Example 4

The coefficient of thermal expansion performance of wafer level underfill (WLU) materials is determined. 10 micron films of the material, prepared as per Example 3 are cast on Teflon slabs (with the dimensions 4″×4″×0.25″) and dried at 40 degrees Celsius and 100 mmHg overnight to give a clear hard film, which is then further dried at 85 degrees Celsius and 150 mmHg. The film is cured according to the method of Example 3 and coefficient of thermal expansion (CTE) values measured by thermal mechanical analysis (TMA). The samples are cut to 4 mm width using a surgical blade and the CTE is measured using a thin film probe on the TMA.

Thermal Mechanical Analysis is performed on a TMA 2950 Thermo Mechanical Analyzer from TA Instruments. Experimental parameters are set at: 0.05 Newtons of force, 5.000 grams static weight, nitrogen purge at 100 ml/min, and 2.0 sec/pt sampling interval. The sample is equilibrated at 30 degrees Celsius for 2 minutes, followed by a temperature ramp at 5.00 degrees Celsius/min to 250.00 degrees Celsius, equilibrated for 2 minutes, then ramped downward at 10.00 degrees Celsius/min to 0.00 degrees Celsius, equilibrated for 2 minutes, and then ramped up at 5.00 degrees Celsius/min to 250.00 degrees Celsius.

Table 3 below provides the CTE data obtained. The results for the second and third entries in Table 3 are obtained on films that are transparent, in contrast to films generated from the same compositions in which 5-micrometer fused silica is used. Both the 5 micron fused silica and the functionalized colloidal silica are used at the same loading rate of 50 weight percent. Moreover, the reduction in CTE exhibited by these materials (Table 3, second and third entries) over the unfilled resin. (Table 3, entry 1) indicates that the functionalized colloidal silica may be effective in reducing resin CTE.

TABLE 3
CTE of resins

| | CTE Below | CTE Above |
|---|---|---|
| | glass transition | glass transition |
| | temperature | temperature (μm/m |
| Entry # | (μm/m degrees Celsius) | degrees Celsius) |
| unfilled resin | 70 | 210 |
| Table 2, Entry 1 | 46 | 123 |
| (TPP level 0.015 g) | | |
| Table 3, Entry 3 | 40 | 108 |
| (NMI level 0.0075 g) | | |

### Example 5

Solder wetting and reflow experiments. The following experiments are carried out in order to demonstrate the wetting action of solder bumps in the presence of the wafer level underfill, as prepared in Examples above.

Part A:

Bumped flip chip dies are coated with a layer of the experimental underfill material from Example 3. This underfill coating contained a substantial amount of solvent, about 30 weight percent. In order to drive off this solvent, the coated chips are baked in a vacuum oven at 85 degrees Celsius and 150 mmHg. This resulted in the tip of the solder bumps being exposed, and a transparent B-stage resin layer coated the entire active surface of the chip.

Part B:

To ensure that the wetting ability of the solder bumps is not hindered by the presence of this B-stage layer, a thin coating of flux is applied to a Cu-clad FR-4 coupon (a glass epoxy sheet laminated with copper commercially available from MG Chemicals). The flux (KESTER TSF 6522 TACFLUX) is applied only in the area where the solder bumps would contact the copper surface. This assembly is then subjected to reflow in a Zepher convection reflow oven (MannCorp). After reflow, the dies are manually sheared off, and inspected for wet-out solder on the copper surface. Molten solder that had wet the copper surface remained adhered to the board, indicating that the wetting ability, in the presence of tacky flux, is not hindered by the B-staged layer of wafer level underfill material.

Part C:

Coated chips are prepared using the methodology described in Part A. These chips are assembled on to a test board, with a daisy chain test pattern. The test board used is a 62 mil thick FR-4 board commercially available from MG Chemicals. The pad finish metallurgy is Ni/Au. Tacky flux (KESTER TSF 6522) is syringe dispensed onto the exposed pads on the test board, using a 30 gauge needle tip and an EFD manual dispenser (EFD, Inc.). The dies are placed on the board with the help of an MRSI 505 automatic pick and place machine (Newport/MSRI Corp.). This assembly is then subjected to reflow in a Zepher convection reflow oven. Electrical resistance readings of ˜2 ohms (measured with a Fluke multimeter) indicated that the solder had wet the pads in the presence of the wafer level underfill. X-ray analysis of the chip assembly attached to the Cu pads for both a control die and a die coated with the composition of the disclosure is conducted utilizing an X-ray machine having a MICROFOCUS X-ray tube. The results of the X-ray analysis indicated solder wetting of the Cu pads, in that the solder bumps showed similar solder ball morphology for both the control and experimental resins after reflow.

### Example 6

Preparation of functionalized colloidal silica (FCS) predispersion. A functionalized colloidal silica predispersion is prepared by combining the following: 1035 grams of isopropanol is slowly added by stirring to 675 grams of aqueous colloidal silica (Snowtex OL, Nissan Chemical Company) containing 20-21 weight weight percent of 50 nanometers particles of SiO2. Subsequently, 17.6 grams phenyl trimethoxysilane (PTS) (Aldrich), is added to the stirred mixture. The mixture is then heated to 80 degrees Celsius for 1-2 hours to afford a pre-dispersion of functionalized colloidal silica that is stored at room temperature.

### Example 7

Preparation of dispersion of a functionalized colloidal silica in solvents. A round bottom 2000 ml flask is charged with 540 grams of each of the pre-dispersions, prepared in Example 6. Additional pre-dispersion compositions may be shown in Table 4, below. 1-methoxy-2-propanol (750 g) is then added to each flask. The resulting dispersion of functionalized colloidal silica is vacuum stripped at 60 degrees Celsius and 60 mmHg to remove about 1 L of solvents. The vacuum is slowly decreased and solvent removal continued with good agitation until the dispersion weight had reached 80 grams. The dispersion of phenyl-functionalized colloidal silica contained 50 weight percent SiO₂ and no precipitated silica. This dispersion is stable at room temperature for more than three months. The results in Table 4 show that a certain level of phenyl functionality may be required in order to prepare a concentrated, stable FCS dispersion in 1-methoxy-2-propanol (Dispersions 1-4,6). A composition from Example 2, Table 1 entry 3 (listed on Table 4 at entry 6) is may included for comparison.

TABLE 4

| | | Final Dispersion | |
|---|---|---|---|
| | Pre-dispersion | Concentration (size) | Dispersion |
| | Composition | (wt weight percent | Stability (in |
| Entry# | (PTS/100 g SiO2) | SiO2) | methoxypropanol) |
| 1 | 0.067 m/100 g | 47 weight percent SiO2 - | Marginally stable |
| | | 50 nm | |
| 2 | 0.0838 m/100 g | 50 weight percent | Stable |
| | | SiO2 - 50 nm | |
| 3 | 0.134/100 g | 50 weight percent SiO2 - | Stable |
| | | 50 nm | |
| 4 | 0.268 m/100 g | 50 weight percent SiO2 - | Stable |
| | | 50 nm | |
| 5 | 0.134/100 g | 47 weight percent SiO2 - | Stable |
| | | 50 nm | |
| 6 | 0.134/100 g | 50 weight percent SiO2 - | Stable |
| | | 20 nm | |

### Example 8

Preparation of a dispersion of functionalized colloidal silica in epoxy resin. A solution combining 5.33 grams of epoxy cresol novolac (ECN 195XL-25 available from Sumitomo Chemical Co.), 2.6 grams of novolac hardener (TAMANOL 758 available from Arakawa Chemical Industries) in 3.0 grams of 1-methoxy-2-propanol is heated to about 50 degrees Celsius. A 7.28 grams portion of the solution is added, dropwise, to 10.0 grams of the FCS dispersion, by stirring at 50 degrees Celsius (see, Table 4, entry #3, 50 weight percent SiO₂ in methoxypropanol, above). The clear suspension is cooled and a catalyst solution of N-methylimidazole, 60 microliters of a 50 percent w/w solution in methoxypropanol is added by stirring. The clear solution is used directly to cast resin films for characterization or stored at −10 degrees Celsius. Additional films are prepared using differing catalysts in various amounts and variations in the epoxy/hardener composition and various FCS dispersions as set forth in Table 5 below which shows final resin compositions.

Films are cast by spreading a portion of the epoxy-silica dispersion on glass plates, and the solvent is removed in vacuum oven at 90 degrees Celsius/200 mmHg for 1 hour and 90 degrees Celsius/100 mmHg for an additional hour. The glass plates are removed and the remaining film is a clear and solid B-stage material. In some cases, the dry film is cured at 220 degrees Celsius for 5 minutes followed by heating at 160 degrees Celsius for 60 minutes. Glass transition temperature measurements are obtained by Differential Scanning Calorimetry using a commercially available DSC from Perkin Elmer. The results of DSC analysis are set forth below in Table 6. Methoxy-propanol is abbreviated MPol.

TABLE 5

| | Filler* | | | | | | Catalyst |
|---|---|---|---|---|---|---|---|
| | (Wt % | Epoxy | Epoxy B | Hardener A | Hardener | MPol | (weight |
| Sample # | SiO2) | A (g)** | (g)** | (g)** | B (g)*** | (g) | percent)**** |
| 1 | 0 | ECN | — | TAMANOL | — | 3 | 0.14 |
| | | (5.3) | | (2.6) | | | |
| 2 | Denka | ECN | — | TAMANOL | — | 3 | 0.14 |
| | 40 | (5.3) | | (2.6) | | | |
| 3 | Table | ECN | — | TAMANOL | — | 3 | 0.14 |
| | 4, #6 | (5.3) | | (2.6) | | | |
| | (50) | | | | | | |
| 4 | Table | ECN | — | TAMANOL | — | 3 | 0.14 |
| | 4, #6 | (5.3) | | (2.6) | | | |
| | (10) | | | | | | |
| 5 | Table | ECN | — | TAMANOL | — | 3 | 0.14 |
| | 4, #6 | (5.3) | | (2.6) | | | |
| | (15) | | | | | | |
| 6 | Table | ECN | — | TAMANOL | — | 3 | 0.14 |
| | 4, #1 | (5.3) | | (2.6) | | | |
| | (20) | | | | | | |
| 7 | Table | ECN | — | TAMANOL | — | 3 | 0.14 |
| | 4, #1 | (5.3) | | (2.6) | | | |
| | (30) | | | | | | |
| 8 | Table | ECN | UVR6105 | HRJ (2.6) | — | 3 | 0.14 |
| | 4, #1 | (5.0) | (0.475) | | | | |
| | (30) | | | | | | |
| 9 | Table | ECN | UVR6105 | HRJ (2.6) | — | 3 | 0.14 |
| | 4, #1 | (5.0) | (0.475) | | | | |
| | (60) | | | | | | |
| 10 | Table | ECN | UVR6105 | HRJ (2.6) | — | 3 | 0.14 |
| | 4, #1 | (4.5) | (0.945) | | | | |
| | (50) | | | | | | |
| 11 | Table | ECN | UVR6105 | HRJ (2.6) | — | 3 | 0.14 |
| | 4, #1 | (4.0) | (1.52) | | | | |
| | (50) | | | | | | |
| 12 | Table | ECN | — | TAMANOL | — | 2.7 | 0.14 |
| | 4, #5 | (4.9) | | (2.4) | | | |
| | (10) | | | | | | |
| 13 | Table | ECN(4.9) | — | TAMANOL | — | 2.7 | 0.14 |
| | 4, #5 | | | (2.4) | | | |
| | (20) | | | | | | |
| 14 | Table | ECN | — | TAMANOL | — | 2.7 | 0.14 |
| | 4, #5 | (4.9) | | (2.4) | | | |
| | (30) | | | | | | |
| 15 | Table | ECN | — | TAMANOL | — | 2.7 | 0.14 |
| | 4, #5 | (4.9) | | (2.4) | | | |
| | (40) | | | | | | |
| 16 | Table | ECN | — | TAMANOL | — | 2.7 | 0.14 |
| | 4, #5 | (4.9) | | (2.4) | | | |
| | (50) | | | | | | |
| 17 | Table | ECN | DER 732 | TAMANOL | — | 1.4 | 0.14 |
| | 4, #5 | (2.2) | (0.4) | (1.2) | | | |
| | (50) | | | | | | |
| 18 | Table | ECN | DER 736 | TAMANOL | — | 1.4 | 0.14 |
| | 4, #5 | (2.2) | (0.3) | (1.2) | | | |
| | (50) | | | | | | |
| 19 | Table4, | ECN | — | TAMANOL | Hydroquinone | 1.6 | 0.14 |
| | #5 (30) | (2.8) | | (1.1) | (0.5) | | |
| 20 | Table | ECN | — | TAMANOL | Hydroquinone | 1.3 | 0.14 |
| | 4, #5 | (2.4) | | (0.9) | (0.5) | | |
| | (40) | | | | | | |
| 21 | Table | ECN | — | TAMANOL | Resorcinol | 1.6 | 0.14 |
| | 4, #5 | (2.8) | | (1.1) | (0.5) | | |
| | (30) | | | | | | |
| 22 | Table | ECN | — | TAMANOL | Resorcinol | 1.3 | 0.14 |
| | 4, #5 | (2.4) | | (0.9) | (0.5) | | |
| | (40) | | | | | | |

*Filler refers to the weight of SiO₂ in the final formulation in the form of functionalized colloidal silica as described in Table 4. The filler specified as DENKA may be a 5 micron fused silica filler (FB-5LDX) available from Denka Corporation.
**ECN refers to ESCN 195XL-25 available from Sumitomo Chemical Co. Epoxy B may be UVR6105, 3-cyclohexenyl methyl-3-cyclohexenyl carboxylate diepoxide available from Dow Chemical Co. (Midland, Michigan). DER 732 may be a polyglycol diepoxide, and DER 736 may be a polyglycol diepoxide, both commercially available from Dow Chemical.
***Hardeners may be TAMANOL 758 or HRJ1583 oligomeric resins available from Arakawa Chemical Industries and Schenectady International respectively or monomeric hydroquinone or resorcinol purchased from Aldrich Chemical.
****Catalyst (N-methylimidazole) loading may be based on organic components excluding solvent.

### Example 9

Flow performance of 50 nm Functionalized colloidal silica formulations. Resin films containing lead eutectic solder balls are prepared by casting a film of resin compositions described in Table 5 onto glass slides. Lead eutectic solder balls (25 mil diameter, mp 183 degrees Celsius) are placed in this film by compressing two glass slides together to insure that the balls are immersed in the resin film. These assemblies are then heated in an oven at 90 degrees Celsius/200 mm for 1 hour and 90 degrees Celsius/100 mm for an additional hour to remove all solvent and convert the resin film into a hard, B-stage film with embedded solder balls. The films, when cooled to ambient temperature are generally hard as noted in Table 6. A test of the resin flow and fluxing capability is performed by placing the glass slide onto copper clad FR-4 circuit board onto which a drop of KESTER FLUX (product TSF-6522 available from the Kester division of Northrup Grumman) had been placed. The glass slide is positioned such that the solder ball/resin film is in contact with the flux. The entire assembly is then placed onto a hot plate that is maintained at 230-240 degrees Celsius. Solder balls exhibited acceptable flow and fluxing performance when the solder balls collapse and flow together. In contrast, resins with poor flow and fluxing characteristics prevented solder ball collapse and the original solder ball morphology is visually evident. Good flow and flux performance to enable solder ball melting and collapse may form good electrical connections in a device and the test described above may be a measure of utility in device fabrication.

The results summarized in Table 6 indicate that transparent films may be prepared with 50 nanometers functionalized colloidal silica (entries 6,7 and 12-16) versus compositions based on conventional 5 micron filler (entry 2) although the films while of acceptable clarity may be not as clear as with compositions based on 20 nanometers functionalized colloidal silica (entries 3-5). However, the addition of small amounts of a cycloaliphatic epoxy monomer, UVR 6105, gives transparent films even at increased loadings of 50 nanometers functionalized colloidal silica (entries 8-11). Moreover, the results of entries 8-11 show that film hardness may be preserved over a range of UVR 6105 levels.

TABLE 6

| Sample | | | B- | | Solder |
|---|---|---|---|---|---|
| # | Material | T_{g}* | stage** | Clarity*** | ball collapse**** |
| 1 | Table 5, | 190 | hard | Transparent | Complete (excellent) |
| | #1 | | | | |
| 2 | Table 5, | 193 | hard | opaque | Complete (excellent) |
| | #2 | | | | |
| 3 | Table 5, | 184 | hard | Transparent | No collapse, very poor |
| | #3 | | | | |
| 4 | Table 5, | 185 | hard | Transparent | Complete (good) |
| | #4 | | | | |
| 5 | Table 5, | — | hard | Transparent | Marginal, poor |
| | #5 | | | | |
| 6 | Table 5, | — | hard | Translucent | Complete (excellent) |
| | #6 | | | | |
| 7 | Table 5, | 180 | hard | Translucent | Marginal, acceptable |
| | #7 | | | | |
| 8 | Table 5, | 158 | hard | Transparent | Complete (excellent) |
| | #8 | | | | |
| 9 | Table 5, | 153 | hard | Transparent | Complete (excellent) |
| | #9 | | | | |
| 10 | Table 5, | 160 | hard | Transparent | Complete (excellent) |
| | #10 | | | | |
| 11 | Table 5, | 157 | tacky | Transparent | Complete (excellent) |
| | #11 | | | | |
| 12 | Table 5, | 183 | hard | Translucent | Complete (excellent) |
| | #12 | | | | |
| 13 | Table 5, | 183 | hard | Translucent | Complete (excellent) |
| | #13 | | | | |
| 14 | Table 5, | 187 | hard | Translucent | Complete (excellent) |
| | #14 | | | | |
| 15 | Table 5, | 190 | hard | Translucent | Marginal, acceptable |
| | #15 | | | | |
| 16 | Table 5, | 203 | hard | Translucent | Marginal, poor |
| | #16 | | | | |
| 17 | Table 5, | 163 | hard | Translucent | Complete (excellent) |
| | #17 | | | | |
| 18 | Table 5, | 171 | hard | Translucent | Complete (excellent) |
| | #18 | | | | |
| 19 | Table 5, | 183 | hard | Translucent | Complete (excellent) |
| | #19 | | | | |
| 20 | Table 5, | 180 | hard | Translucent | Complete (excellent) |
| | #20 | | | | |
| 21 | Table 5, | 177 | hard | Translucent | Complete (excellent) |
| | #21 | | | | |
| 22 | Table 5, | 160 | hard | Translucent | Complete (excellent) |
| | #22 | | | | |

*glass transition temperature refers to the glass transition temperature of a given material cured under standard reflow conditions as measured by DSC.
**B-stage corresponds to the state of the film after solvent removal.
***Based on a visual inspection of the film after solvent removal. Transparent may be used to designate the best clarity, Translucent may be used to designate acceptable clarity for this application (i.e. no adverse effects on wafer dicing process) and opaque may be used to designate unacceptable clarity.
****Based on visual inspection during and after heating at 200-240 degrees Celsius.

The results of Table 6 indicate that the base resin (entry 1) exhibits good flow as shown by excellent solder ball collapse; however, this resin has an unacceptably high CTE value and would be expected to give poor reliability when used as a wafer level underfill in flip-chip devices. The use of conventional 5 micron filler (entry 2) gives lower CTE while preserving excellent solder ball collapse but leads to a loss of transparency required for wafer dicing operations. The use of 20 nanometers filled systems gives excellent transparency but leads to a loss in flow as shown by unacceptably poor solder ball collapse (entry 3) at a filler loading comparable to that used with the 5 micron filler. Good solder ball collapse may be observed at 10 weight percent SiO₂ 20 nanometers filler but not at greater than 15 weight percent SiO₂ 20 nanometers filler (entries 3 and 4 respectively). Use of 50 nanometers filler (Table 4, entries 6 and 7) show a substantial increase in flow as shown by good solder ball collapse at up to 30 weight percent filler. Furthermore, addition of a cycloaliphatic epoxy resin to the formulations provides both a substantial gain in flow as well as better film transparency with a similar result being obtained with addition of aliphatic epoxy resins (Table 6, entries 8-11 and 17-18 respectively). Furthermore, similar improvements in flow may be also realized with combinations of 50 nanometers filler and monomeric hardeners that may include some dihydroxy compounds (Table 6, entries 19-22).

### Example 10

Preparation of difunctional siloxane anhydride. A 500 milliliter (ml) flask equipped with mechanical stirrer, thermometer, condenser, addition funnel and nitrogen inlet is charged with 127 grams (0.77 mols) of 5-norbornene-2,3-dicarboxylic anhydride, 150 grams of toluene and 20 ppm of platinum as KARSTEDT'S catalyst (i.e., a complex of Pt⁰ with divinyl tetramethyl disiloxane as described in U.S. Pat. No. 3,775,442). The solution is heated to 80 degrees Celsius and 84.3 grams (0.4 mols) of 1,1,3,3,5,5-hexamethyltrisiloxane is added drop-wise to the reaction mixture. A mild exotherm occurs and the temperature is raised to 100 degrees Celsius. The addition of silicone hydride is completed in 1 hour. The reaction mixture is stirred at 80 degrees Celsius for an additional hour. Infrared (IR) analysis is conducted using an Avatar 370 FT-IR (from Thermo Electron Corporation); the results showed 75 percent conversion of Si—H groups. An additional 20 ppm of the platinum catalyst is added and the reaction mixture is heated to 80 degrees Celsius with stirring under nitrogen over night. The next morning, IR analysis is again conducted; the results showed more than 99 percent consumption of Si—H. The reaction mixture is cooled to room temperature.

The cooled reaction mixture is then mixed with 300 ml of hexane. A precipitation of white powder is observed. The solid material is separated by filtration and dried in vacuum oven at 50 degrees Celsius to afford 180 grams of the desired difunctional siloxane anhydride. ¹H, ²⁹Si NMR is conducted using a 400 MHz BRUKER AVANCE 400 to confirm both the structure and purity of the anhydride. The BRUKER AVANCE 400 may be commercially obtained from the Bruker BioSpin Corporation (Billerica, Mass.).

### Example 11

Preparation of functionalized colloidal silica pre-dispersion. A functionalized colloidal silica pre-dispersion is prepared using the following procedure. 465 grams of aqueous colloidal silica (NALCO 1034A, Nalco Chemical Company) containing about 34 weight percent of 20 nanometers particles of silica, is mixed with 800 grams of isopropanol and 56.5 grams of phenyl trimethoxy silane by stirring. The mixture is heated to 60 to 70 degrees Celsius for 2 hours to give a clear suspension. The resulting pre-dispersion is cooled to room temperature and stored in a glass bottle.

### Example 12

Preparation of resin containing stabilized functionalized colloidal silica. A 1000-milliliter (ml) flask is charged with 300 grams of the colloidal silica pre-dispersion from Example 11, 150 grams of 1-methoxy-2-propanol as solvent and 0.5 grams of crosslinked polyvinylpyridine. The mixture is stirred at 70 degrees Celsius. After 1 hour the suspension is blended with 4 grams CELITE® 545 (a commercially available diatomaceous earth filtering aid), cooled down to room temperature and filtered. The resulting dispersion of functionalized colloidal silica is blended with 30 grams of 3,4-epoxy cyclohexyl methyl-3,4-epoxy cyclohexane carboxylate (UVR6105 from Dow Chemical Company) and 10 grams of bisphenol-F epoxy resins (RSL-1739) and vacuum stripped at 75 degrees Celsius at 1 Torr to a constant weight to yield 88.7 grams of a viscous liquid resin.

### Example 13

Preparation of epoxy fluxing compositions. 5 grams of the functionalized colloidal silica resin of Example 12 is blended at room temperature with 1.56 grams of 4-methyl-hexahydrophthalic anhydride (MHHPA) (from Aldrich) and 1.56 grams of 5,5′-(1,1,3,3,5,5-hexamethyl-1,5-trisiloxanediyl) bis [hexahydro-4,7-methanoisobenzofuran-1,3-dione] (TriSDA) (e.g., difunctional siloxane anhydride product of Example 10). 0.01 grams of catalyst (POLYCAT SA-1 from Air Products) and 0.07 grams of γ-glycidoxypropyltrimethoxysilane (GE Silicones) are added at room temperature. The formulations are blended at room temperature for approximately 10 minutes. The formulation is degassed at high vacuum at room temperature for 20 minutes. The resulting materials are stored at −40 degrees Celsius.

### Example 14

Chip coating procedure. Silicon die and quartz die are coated with the wafer level underfill material described above in Table 2, entry 9 of Example 3. The silicon die is a perimeter array PB08 with 8 mil pitch, nitride passivation, diced from a wafer purchased from DELPHI DELCO ELECTRONICS. The quartz die is a perimeter array, 8 mil pitch, diced from a wafer purchased from PRACTICAL COMPONENTS. The underfill material is printed onto individual die using a mask fixture such that the tops of the solder balls are covered. A B-stage process is carried out by placing the coated die in a vacuum oven so that the die are subjected to a surface temperature of 95 degrees Celsius and vacuum of 200 mmHg for one hour, followed by an additional one hour at 100 mmHg. The die are removed from the oven and allowed to cool to room temperature.

A copper clad FR4 board (commercially available from MG Chemicals) is cleaned by sanding with 180 grit paper followed by thorough cleaning with isopropanol and a lint free cloth. Two different fluxing resins are examined. In each case a center dot dispense of fluxing agent is applied to the clean board using an EFD 1000 series dispenser followed by placement of the quartz coated die. The test assembly is then passed through a Zepher convection reflow oven using a typical reflow profile: the maximum temperature rising slope is 2.1 degrees Celsius/second; the time between 130 degrees Celsius and 160 degrees Celsius is 53 seconds; the temperature rising time above 160 degrees Celsius is 120 seconds; the time between 160 degrees Celsius and 183 degrees Celsius is 74 seconds; and the time above 183 degrees Celsius is 70 seconds, with a maximum temperature of 216 degrees Celsius followed by a temperature decrease of 2.5 degrees Celsius per second.

Three chip/board assemblies are prepared. For the first assembly, a tacky flux (KESTER TSF 6522 TACFLUX) is dispensed on the FR4 copper clad board and utilized as the fluxing agent. A quartz die coated with the wafer level underfill composition described above in Table 2, entry 9 of Example 3 is then applied to the fluxing resin and subjected to reflow. Examination of this assembly after reflow showed extensive, unacceptable voiding although good solder wetting is noted.

For the second assembly, the fluxing resin of Example 13 above is dispensed on the FR4 copper clad board. A quartz die coated with the wafer level underfill composition described above in Table 2, entry 9 of Example 3 is then applied to the fluxing resin and subjected to reflow. Examination after reflow of this assembly showed no voiding and evidence of excellent adhesion.

For the third assembly, the fluxing resin of Example 13 above is dispensed on the FR4 copper clad board. A silicon die coated with the wafer level underfill composition described above in Table 2, entry 9 of Example 3 is then applied to the fluxing resin and the assembly subjected to reflow. Examination after reflow of this assembly shows excellent adhesion. Removal of the die shows no voiding present. This example demonstrates the benefit of using solvent-modified epoxy resin in producing B-stage resin films, in combination with a second fluxing resin to produce void-free, high adhesion, conductive chip assemblies.

### Example 13

Active termination site density versus stability.

Samples 13A-13H are prepared as follows. A slurry of functionalized colloidal silica nano-particles having a solids weight percentage of 32.9 is added with a passivating agent as shown in Table 7. The passivating agent is hexamethyl disilazane (HMDZ), and the filler and passivating agent are mixed, reacted and cooled. Solids content is measured for each of the samples 13A-13H, the results are listed in Table 7. To each of the samples are added 7.5 grams of a first curable resin (3-cyclohexenyl methyl-3-cyclohexenyl carboxylate diepoxide (UVR6105)); 2.5 grams of a second curable resin (bisphenol-F epoxy resin (RSL-1739)); and a solvent (SR83-068). The samples are mixed and then vacuum stripped at high vacuum.

TABLE 7
Samples 13A-13H preparation of filler in curable resin
systems with differing amounts of passivating agent.

| | Sample | Sample | Sample | Sample | Sample | Sample | Sample | Sample |
|---|---|---|---|---|---|---|---|---|
| Formulation | 13A | 13B | 13C | 13D | 13E | 13F | 13G | 13H |
| Filler | 50 | 50 | 50 | 50 | 50 | 50 | 50 | 50 |
| Passivating agent | 0.1 | 0.25 | 0.5 | 1 | 1.5 | 1.75 | 2 | 3 |
| HMDZ mmols/ | 0.0378 | 0.0944 | 0.1888 | 0.3776 | 0.5664 | 0.6608 | 0.7552 | 1.1327 |
| g SiO2 | | | | | | | | |
| Solids content | 0.34 | 0.332 | 0.334 | 0.3317 | 0.33 | 0.333 | 0.329 | 0.3202 |
| Curable resin A | 7.5 | 7.5 | 7.5 | 7.5 | 7.5 | 7.5 | 7.5 | 7.5 |
| Curable resin B | 2.5 | 2.5 | 2.5 | 2.5 | 2.5 | 2.5 | 2.5 | 2.5 |
| SR83-068 | 24.1 | 24.7 | 24.6 | 24.7 | 24.8 | 24.6 | 24.9 | 25.6 |
| m = | 18.06 | 18.2 | 18.37 | 18.7 | 18.11 | 18.07 | 18.93 | 18.67 |

The samples are then measured for initial viscosity using a Brookfield-type viscometer. Spindle 1, 133 l/second, all viscosity results are in centipoise, unless otherwise stated, and are listed in Table 8. Additionally, data is plotted in Graph 1 showing that increasing amounts of passivating agent reduce initial viscosity. It may be that decreased hydrogen bonding facilitates movement of particles in a filled system.

TABLE 8
Initial viscosity measurements.

| | Sample | Sample | Sample | Sample | Sample | Sample | Sample | Sample |
|---|---|---|---|---|---|---|---|---|
| | 13A | 13B | 13C | 13D | 13E | 13F | 13G | 13H |
| Initial Visc. | 17756 | 14700 | 10440 | 9040 | 9000 | 9937 | 9620 | 7669 |

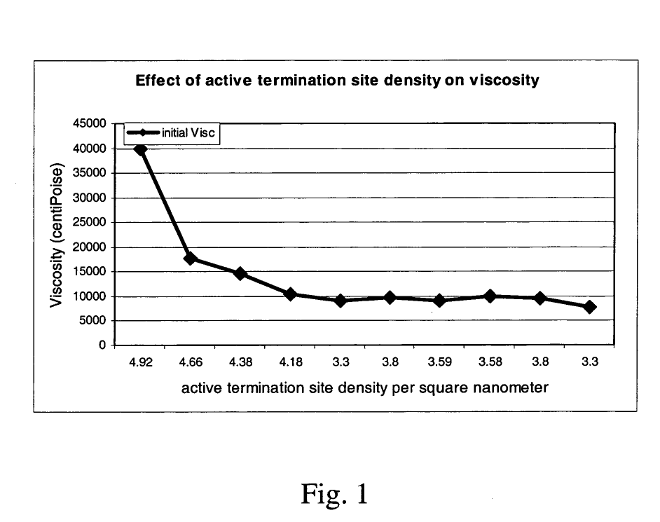

FIG. 1 is a graph that illustrates a relationship between active termination site density and initial viscosity. For silica, the viscosity curve apex is about 4.5. That is, fewer than about 4.5 active termination sites per square nanometer result in a resin system with a relatively lower initial viscosity.

The samples are then measured for subsequent viscosity in a similar manner as the initial viscosity, but one week later than the initial viscosity and one week of aging at 60 degrees Celsius. The results are shown in Table 9.

TABLE 9
Viscosity measurements (cPs) after one week of aging at 60 degrees Celsius.

| Viscosity | Sample | Sample | Sample | Sample | Sample | Sample | Sample | Sample |
|---|---|---|---|---|---|---|---|---|
| measurement | 13A | 13B | 13C | 13D | 13E | 13F | 13G | 13H |
| Spindle 1, 133 1/s | — | — | 15190 | 10090 | 9750 | 11006 | 10519 | 8756 |
| Spindle 6, 33 1/s | 60700 | — | — | — | — | — | — | — |
| Spindle 6, 50 1/s | 161000 | — | — | — | — | — | — | — |
| Spindle 6, 67 1/s | 361500 | 37900 | — | — | — | — | — | — |
| Spindle 6, 133 1/s | — | 124100 | — | — | 12200 | — | — | — |
| Spindle 6, 333 1/s | — | — | — | — | 18200 | — | — | — |

The samples are then measured for subsequent viscosity in a similar manner as the initial viscosity, but one week later than the initial viscosity and two weeks of aging at 60 degrees Celsius. The results are shown in Table 10.

TABLE 10
Viscosity measurements (cPs) after two weeks of aging at 60 degrees Celsius.

| Viscosity | Sample | Sample | Sample | Sample | Sample | Sample | Sample | Sample |
|---|---|---|---|---|---|---|---|---|
| measurement | 13A | 13B | 13C | 13D | 13E | 13F | 13G | 13H |
| Spindle 6, 33 1/s | >1,000,000 | 225700 | 23300 | 16500 | 15000 | 15000 | 13500 | 13500 |
| Spindle 6, 67 1/s | — | 303000 | 27400 | 16100 | 13500 | 13500 | 12800 | 11600 |

The samples are initially measured for active termination sites or Bronsted sites using Nuclear Magnetic Resonance Imaging (NMR). Also, the surface area of the filler material is determined using corrected BET-C. Results are shown in Table 11.

TABLE 11
and surface area data for samples 13A-13H.

| | Sample | Sample | Sample | Sample | Sample | Sample | Sample | Sample |
|---|---|---|---|---|---|---|---|---|
| Si NMR data | 13A | 13B | 13C | 13D | 13E | 13F | 13G | 13H |
| M | 0.2% | 0.6% | 1.7% | 3.7% | 4.8% | 4.8% | 5.8% | 7.3% |
| TOH | 2.2% | 2.4% | 2.2% | 2.1% | 1.9% | 1.9% | 1.8% | 1.7% |
| T | 2.0% | 2.1% | 2.5% | 2.8% | 2.5% | 2.4% | 2.7% | 3.0% |
| QOH | 54.4% | 52.6% | 48.6% | 45.8% | 45.0% | 45.6% | 43.2% | 41.4% |
| Q | 41.2% | 42.3% | 45.1% | 45.6% | 46.0% | 45.3% | 46.4% | 46.5% |
| BET-C Data | — | — | — | — | — | — | — | — |
| Surface Area | 167.10 | 163.90 | 161.10 | 145.00 | 150.90 | 151.00 | 148.90 | 143.60 |
| (Corrected) | | | | | | | | |
| BET-C value | 57.53 | 52.35 | 48.68 | 32.50 | 37.95 | 37.72 | 34.70 | 32.63 |
| SiOH/nm\hat{ }2 | 4.66 | 4.38 | 4.18 | 3.30 | 3.59 | 3.58 | 3.41 | 3.30 |

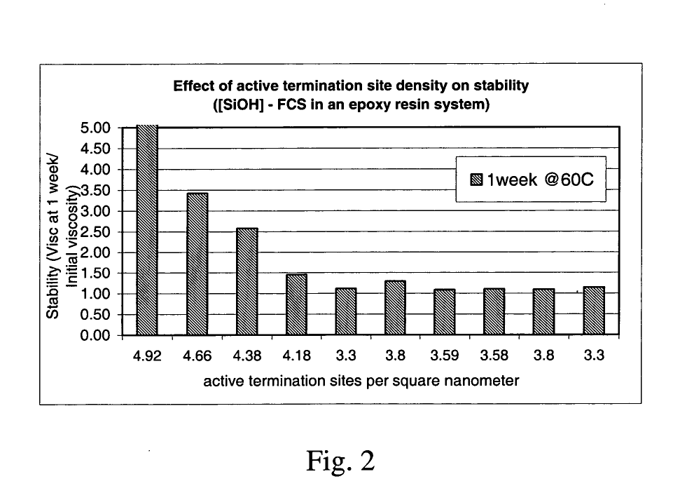

FIG. 2 shows a graph that illustrates the relationship of density of active termination sites to stability. That is, a function of viscosity increase over time as related to the number of silanol groups per square nanometer of surface area, in this instance. Of note is that there are a measurable number of active termination sites, and that number is controllable. By controlling the number of active termination sites, the formulation instability, or viscosity rise attributable to premature cross-linking of the curable monomer, is controllable.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A finely divided refractory solid having:
a surface area that is greater than about 5 square meters per gram; and
a density of active surface termination sites per square nanometer of surface area sufficiently low that a curable composition comprising a curable resin that comprises less than about 99 percent by weight of the solid has a stability ratio of less than about 3 after a period of about two weeks.

2. The solid as defined in claim 1, wherein the surface area is greater than about 20 square meters per gram.

3. The solid as defined in claim 2, wherein the surface area is greater than about 60 square meters per gram.

4. The solid as defined in claim 3, wherein the surface area is greater than about 150 square meters per gram.

5. The solid as defined in claim 17 wherein the stability ratio is about 1.

6. The solid as defined in claim 5, wherein the density of active surface termination sites is about 4.75 or less.

7. The solid as defined in claim 5, wherein the density of active surface termination sites is in a range of from about 4.5 to about 4.0.

8. The solid as defined in claim 1, wherein the solid comprises a plurality of nano-particles having an average diameter in a range of from about 1 nanometer to about 100 nanometers.

9. The solid as defined in claim 8, wherein each of the plurality of nano-particles have a spherical, amorphous or geometric morphology.

10. The solid as defined in claim 8, wherein each of the plurality of nano-particles are non-porous.

11. The solid as defined in claim 1, wherein the solid comprises one or more of aluminum, antimony, arsenic, beryllium, boron, carbon, chromium, copper, gallium, gold, germanium, indium, iron, hafnium, magnesium, manganese, molybdenum, phosphorous, silicon, silver, titanium, tungsten, or zirconium.

12. The solid as defined in claim 11, wherein the solid comprises an oxide or a nitride of aluminum, antimony, arsenic, beryllium, boron, carbon, chromium, copper, gallium, gold, germanium, indium, iron, hafnium, magnesium, manganese, molybdenum, phosphorous, silicon, silver, titanium, tungsten, or zirconium.

13. The solid as defined in claim 12, wherein the solid comprises silicon oxide and the active surface termination site comprises a silanol group.

14. The solid as defined in claim 12, wherein the solid is a nitride and the active surface termination site comprises an amide or an imide.

15. The solid as defined in claim 12, wherein the solid comprises alumina oxide and the active surface termination site comprises a hydroxyl group.

16. The solid as defined in claim 1, wherein the solid is produced by a sequential treatment, the treatment comprising:
reacting a first portion of active surface termination sites with a functionalizing composition; and
reacting a second portion of active surface termination sites with a passivating composition.

17. The solid as defined in claim 16, wherein the functionalizing composition comprises a silane.

18. The solid as defined in claim 16, wherein the passivating composition comprises a silazane.

19. An adhesive composition, comprising the solid as defined in claim 1, and a curable resin.

20. The adhesive composition as defined in claim 19, wherein the curable resin comprises one or more of an acrylic, urethane, isocyanate, cyanate ester, imide, or epoxy resin.

21. The adhesive composition as defined in claim 20, wherein the epoxy resin is multi-functional.

22. The adhesive composition as defined in claim 20, wherein the curable resin comprises one or more additive.

23. The adhesive composition as defined in claim 19, wherein the solid is present in an amount in a range of greater than about 1 weight percent.

24. The adhesive composition as defined in claim 23, wherein the solid is present in an amount in a range of greater than about 50 weight percent.

25. The adhesive composition as defined in claim 19, wherein the solid is present in an amount sufficient to about match the coefficient of thermal expansion of the adhesive composition to a chip selected for use with the adhesive system.

26. (canceled)

27. The adhesive composition as defined in claim 19, wherein the coefficient of thermal expansion of the adhesive composition, after cure, is less than about 40 ppm/degree Celsius.

28. A cured layer comprising the composition as defined in claim 19, wherein the glass transition temperature of the cured layer is greater than about 150 degrees Celsius.

29. An electronic device, comprising:
a chip;
a substrate; and
the cured layer as defined in claim 28 securing the chip to the substrate.

30. The electronic device as defined in claim 29, wherein the chip comprises one or more of silicon, gallium, germanium or indium.

31. The electronic device as defined in claim 29, wherein the cured layer is an underfill material disposed in a region defined by an inward facing surface of the chip and an inward facing surface of the substrate.

32. A method of producing a filler for a resin system, comprising:
reacting a first portion of active termination sites of a plurality of particles with a functionalizing or phase compatiblizing composition;
reacting a second portion of active termination sites of the plurality of particles with a passivating composition; and
removing a solvent from a solution or slurry comprising the plurality of particles subsequent to reacting the first and second portions.

33. The method as defined in claim 32, wherein reacting the second portion of active termination sites comprises capping or passivating active termination sites on a surface of each particle of the plurality to achieve less than about 4 active termination sites per square nanometer of surface area to stabilize the resin system.

34. The method as defined in claim 32, wherein the phase compatiblizing composition comprises an organosilane.

35. The method as defined in claim 32, wherein the passivating composition comprises a silazane.

36. The method as defined in claim 32, further comprising admixing the filler with the resin system in an amount sufficient to form a filled resin system that is stable for a predetermined length of time at a temperature that is greater than about room temperature.

37. An electronic device, comprising:
a chip;
a substrate, and
means for securing the chip to the substrate.
